(19) United States
(12) Patent Application Publication
(10) Pub. No.: US 2023/0157284 A1
(43) Pub. Date: May 25, 2023

(54) HIGH-LOAD SOLUTION CONCENTRATES OF DICAMBA

(71) Applicant: BASF SE, Ludwigshafen (DE)

(72) Inventors: Claude Taranta, Limburgerhof (DE); Wolfgang Meier, Limburgerhof (DE); Marc Nolte, Limburgerhof (DE); Frank Dinies, Limburgerhof (DE); Stephan Koehler, Ludwigshafen (DE); Michael Krapp, Limburgerhof (DE); Klaus Kolb, Schifferstadt (DE)

(21) Appl. No.: 17/915,603

(22) PCT Filed: Apr. 6, 2020
(86) PCT No.: PCT/US2020/026900

§ 371 Date: Sep. 29, 2022

(51) Int. Cl. A01N 37/40; A01N 25/02

(52) U.S. Cl. CPC A01N 37/40; A01N 25/02

(57) ABSTRACT

The invention relates to an agrochemical composition comprising the potassium salt of dicamba and an adjuvant selected from a) a polyalkylene oxide block-copolymer, b) a hyperbranched polycarbonate, and c) a solvent selected from C₁-C₆-alkyl lactate, C₃-C₆-lactone and N—C₁-C₁₅-alkyl pyrrolidone. It also relates to a method of controlling undesired vegetation, and/or for regulating the growth of plants, wherein the agrochemical composition is allowed to act on the respective pests, their environment, or the crop plants to be protected from the respective pest, on the soil and/or on the crop plants and/or on their environment; to a method for producing the agrochemical composition; to an adjuvant composition for increasing the solubility of the potassium salt of dicamba in an aqueous composition comprising a mixture of additive a) or additive b) with additive c) fine droplet formation.

The invention relates to an aqueous agrochemical composition comprising the potassium salt of dicamba (hereinafter referred to as dicamba-K), and an additive selected from
a) a polyalkylene oxide block-copolymer of formula (I)

R¹O(EO)ₙ(PO)ₘ(EO)ₚR² (I),
wherein
EO is CH₂CH₂O;
PO is CH₂CH(CH₃)O;
R¹, R² are H, or C₁-C₃-alkyl;
n, p are independently a natural number from 10 to 250; and
m is a natural number from 10 to 100;
b) a hyperbranched polycarbonate, which is connected to a linear polymer comprising polyethylene oxide; and
c) a solvent selected from C₁-C₆-alkyl lactate, C₃-C₆-lactone and N—C₁-C₁₅-alkyl pyrrolidone.

It also relates to a method of controlling undesired vegetation, and/or for regulating the growth of plants, wherein the agrochemical composition is allowed to act on the respective pests, their environment, or the crop plants to be protected from the respective pest, on the soil and/or on the crop plants and/or on their environment; and to a method for producing the agrochemical composition comprising contacting dicamba-K, said additive and water.

It also relates to an adjuvant composition for increasing the solubility of dicamba-K in an aqueous composition comprising a additive c) and either additive a) or additive b). and optionally water; and to an adjuvant composition for increasing the solubility of side products of dicamba-K in an aqueous composition comprising additive c) and either additive a) or additive b), and optionally water.

The invention also relates to the use of additive a), b), c), or the adjuvant composition, for increasing the solubility of dicamba-K in an aqueous composition; and to a method for increasing the solubility of dicamba-K in an aqueous composition comprising the step of contacting additive a), b), c), or the adjuvant composition, with dicamba-K and water.

It also relates to the use of additive a), b), c), or the adjuvant composition, for solubilizing side products of dicamba-K in an aqueous composition; and to a method for solubilizing side products of dicamba-K in an aqueous solution comprising the step of contacting additive a), b), c), or the adjuvant composition, with dicamba-K, side products of dicamba-K and water.

Combinations of embodiments with other embodiments, irrespective of their individual level of preference, are within the scope of the invention.

Mitigation of off-target movement of pesticides from the treated area minimizes potential negative environmental effects and maximizes the efficacy of pesticide where it is most needed. By their nature, herbicides affect sensitive plants and mitigating their off-target movement reduces their effect on neighboring crops and other vegetation, while maximizing weed control in the treated field. Off-target movement can occur through a variety of mechanisms generally divided into primary loss (direct loss from the application equipment before reaching the intended target) and secondary loss (indirect loss from the treated plants and/or soil) categories. Primary loss from spray equipment typically occurs as fine dust or spray droplets that take longer to settle and can be more easily blown off-target by wind. Off-target movement of spray particles or droplets is typically referred to as ‘spray drift’. Primary loss can also include when contaminated equipment is used to make an inadvertent application to a sensitive crop. Contamination may occur when one product (i.e. pesticide) is not adequately cleaned from spray equipment and the contaminated equipment is later used to apply a different product to a sensitive crop resulting in crop injury. Secondary loss describes off-target movement of a pesticide after it contacts the target soil and/or foliage and moves from the treated surface by means including airborne dust (e.g. crystalline pesticide particles or pesticide bound to soil or plant particles), volatility (i.e. a change of state from the applied solid or liquid form to a gas), or run-off in rain or irrigation water. Off-target movement is typically mitigated by proper application technique (e.g. spray nozzle selection, nozzle height and wind limitations) and improved pesticide formulation. This is also the case for dicamba where proper application technique mitigates potential primary loss and equipment contamination. Secondary loss for dicamba has been further reduced through the development of formulations using improved dicamba salts such as BAPMA dicamba. It was desirable to provide formulations of dicamba that have advantageous primary—and secondary loss profiles, are safe for the applicant, and have a high biological activity.

Dicamba-K is an advantageous form of dicamba that can be handled easily and safely by the applicant. It was an objective of the invention to find an aqueous-based formulation of dicamba-K with good biological activity, and/or wherein the concentration of dissolved dicamba-K is increased, and/or which are physically and chemically stable. It was also an objective of the invention to find a dicamba formulation that can be mixed with glyphosate and/or glufosinate, their salts and formulations, in order to create pesticidal mixtures that have a good biological activity, which are easy to handle, safe for the applicant, and/or physically and chemically stable.

These objectives were successfully addressed by the aqueous agrochemical composition comprising dicamba-K, and an additive selected from additives a), b) and c) as described herein. Additives a) or b) may herein also be referred to as adjuvants a) or b).

The aqueous agrochemical composition comprises water. The agrochemical composition has a continuous aqueous phase. The water-content may be at least 10 wt %, preferably at least 15 wt %, more preferably at least 20 wt %, most preferably at least 21 wt %, especially preferably at least 22 wt %, and utmost preferably at least 24 wt %, such as at least 25 wt % based on the total weight of the agrochemical composition. The water content may be up to 60 wt %, preferably up to 45 wt %, more preferably up to 40 wt %, most preferably up to 35 wt %, utmost preferably up to 30 wt % based on the total weight of the agrochemical composition. The water content may be from 10 to 50 wt %, preferably from 25 to 40 wt % based on the total weight of the agrochemical composition.

The agrochemical composition comprises dicamba-K. Dicamba-K is commercially available. It can be prepared by reaction of the free acid form of dicamba with KOH. Dicamba-K typically refers to a 1:1 salt of the dicamba anion and potassium.

The agrochemical composition comprises a pesticidally effective amount of dicamba-K. The term “effective amount” denotes an amount of dicamba-K, which is sufficient for controlling pest species or the protection of materials and which does not result in a substantial damage to the crop plants. Such an amount can vary in a broad range and is dependent on various factors, such as pest species, the treated crop plant or material, and the climatic conditions.

The agrochemical composition typically comprises dicamba-K in a concentration of at least 30 wt %, preferably at least 40 wt %, more preferably at least 45 wt %, especially preferably at least 50 wt %, particularly preferably at least 55 wt %, especially preferably at least 56 wt %, and utmost preferably at least 57 wt % based on the total weigh of the agrochemical composition. The agrochemical composition may contain the dicamba-K in a concentration of from 30 to 80 wt %, preferably from 40 to 70 wt %, more preferably from 45 to 60 wt % based on the total weight of the agrochemical composition.

The agrochemical composition typically comprises dicamba-K in a concentration of at least 600 g/l, preferably at least 700 g/l, more preferably at least 720 g/l, especially preferably at least 725 g/l, particularly preferably at least 730 g/A, especially preferably at least 735 g/l, and utmost preferably at least 740 g/l based on the total weigh of the agrochemical composition. The agrochemical composition may contain the dicamba-K in a concentration of from 700 to 1000 g/l, preferably from 725 to 950 g/l, more preferably from 730 to 950 g/l based on the total weight of the agrochemical composition. Dicamba-K is completely dissolved in the agrochemical composition at 20° C.

The agrochemical composition typically contains side products of the dicamba-K manufacturing process. Side products may be 3,5-dichloro-2-methoxybenzoic acid (CAS 22775-37-7), 3,6-dichloro-2-hydroxybenzoic acid (CAS 3401-80-7), 3,5-dichloro-2-hydroxybenzoic acid (CAS 320-72-9), 3-chloro-2,6-dimethoxybenzoic acid (CAS 36335-47-4), 3,4-dichloro-2-methoxybenzoic acid (CAS 155382-86-8), 3,4-dichloro-2-hydroxybenzoic acid (CAS 14010-45-8), and/or 3,5-dichloro-4-methoxybenzoic acid (CAS 37908-97-7), or salts of any of them, such as their potassium salts. These compounds are generally prone to form insoluble precipitates in common liquid agrochemical formulations by sedimentation over time or by forming turbid heterogeneous conglomerates in the liquid formulation. In extreme cases, these instable formulations may result in clogging spray nozzle equipment and make dosing of the concentrated agrochemical formulation more difficult. The inventive formulations of dicamba-K mitigate the problems associated with these side products.

In one embodiment, the agrochemical composition contains the side product 3,5-dichloro-2-methoxybenzoic acid. In another embodiment, the agrochemical composition contains the side product 3,6-dichloro-2-hydroxybenzoic acid. In another embodiment, the agrochemical composition contains the side product 3,6-dichloro-2-hydroxybenzoic acid. In another embodiment, the agrochemical composition contains the side product 3,5-dichloro-2-hydroxybenzoic acid. In another embodiment, the agrochemical composition contains the side product 3-chloro-2,6-dimethoxybenzoic acid. In another embodiment, the agrochemical composition contains the side product 3,4-dichloro-2-methoxybenzoic acid. In another embodiment, the agrochemical composition contains the side product 3,4-dichloro-2-hydroxybenzoic acid. In another embodiment, the agrochemical composition contains the side product 3,5-dichloro-4-methoxybenzoic acid. In another embodiment, the agrochemical composition contains the side products 3,5-dichloro-2-methoxybenzoic acid, 3,6-dichloro-2-hydroxybenzoic acid, and 3,5-dichloro-2-hydroxybenzoic acid.

The concentration of the side product(s) relative to the total mass of dicamba is usually from 1 wt % to 20 wt %. The concentration may be at least 1.5 wt %, preferably at least 2 wt %, more preferably at least 5 wt %. The concentration may be up to 18, preferably up to 15, more preferably up to 10 wt %.

Usually, the concentration of the 3,5-dichloro-2-methoxybenzoic acid relative to the total mass of dicamba may be from 0.5 wt % to 10 wt %, preferably 1 wt % to 8 wt %. The concentration of the 3,6-dichloro-2-hydroxybenzoic acid relative to the total mass of dicamba may be from 0.1 wt % to 10 wt %, preferably 0.1 wt % to 5 wt %. The concentration of the 3,5-dichloro-2-hydroxybenzoic acid relative to the total mass of dicamba may be from 0.1 wt % to 10 wt %, preferably 0.1 wt % to 5 wt %. In one embodiment, the concentration of the 3,5-dichloro-2-hydroxybenzoic acid relative to the total mass of dicamba is up to 5 wt %, preferably up to 3 wt %.

The side product may be present as a free carbonic acid, or in the form of its potassium salt. Preferably it is present in the form of its potassium salt.

It was surprisingly found that these side products, which have a low water-solubility, are kept dissolved in the agrochemical composition. The agrochemical composition stays clear, homogeneous and transparent. No precipitate or sediment is formed.

The agrochemical composition comprises an additive selected from

a) a polyalkylene oxide block-copolymer of formula (I)

R¹O(EO)ₙ(PO)ₘ(EO)ₚR² (I),
wherein
EO is CH₂CH₂O;
PO is CH₂CH(CH₃)O;
R¹, R² are H, or C₁-C₃-alkyl;
n, p are independently a natural number from 10 to 250, preferably 20 to 200; and
m is a natural number from 10 to 100, preferably 20 to 70; and
   b) a hyperbranched polycarbonate, which is connected to a linear polymer comprising polyethylene oxide; and
   c) a solvent selected from C₁-C₆-alkyl lactate, C₃-C₆-lactone and N—C₁-C₁₅-alkyl pyrrolidone.

Additive a) is commercially available. Typical products are products of the products series Pluriol E, Pluronic PE, Genapol PF, and Synperonic PE. Additive a) can be prepared by reaction of ethylene oxide and propylene oxide in a non-aqueous solvent by a ring-opening reaction. Typically, additive a) is prepared in two steps. In the first step, propylene glycol or dipropylene glycol is dissolved in a non-aqueous organic solvent, e.g. petrol ether, and propylene oxide is added either as a gas or as a liquid. Optionally, a catalyst is added to the reaction mixture to increase the reaction yield and dispersity of the reaction product. In the second step, ethylene oxide is added to the reaction mixture to yield the final additive of formula a).

In one embodiment, R¹ and R² in formula I are H. In another embodiment, R¹ and R² in formula I are C₁-C₃-alkyl. In another embodiment, R¹ and R² in formula I are CH₃.

The ratio of (n+p)/m in formula I is typically at least 1:1, preferably at least 3:2. The ratio (n+p)/m in formula I is typically up to 10:1, preferably up to 8:1, more preferably up to 6:1. The ratio of (n+p)/m in formula I is typically at from 1:1 to 10:1, preferably from 1:1 to 9:1, more preferably from 3:2 to 7:1.

In a first embodiment PA-1 of additive a), the indices n and p in formula I are each independently 20 to 100, preferably 30 to 80, more preferably 40 to 70, most preferably 40 to 60, and particularly preferably 45 to 55. In this same embodiment PA-1, the index m in formula I is from 20 to 100, preferably 30 to 80, more preferably 40 to 70, most preferably 50 to 60.

In a second embodiment PA-2 of additive a), the indices n and p in formula I are each independently 50 to 100, preferably 60 to 80, more preferably 65 to 75. In this same embodiment PA-2, the index m in formula I is from 10 to 60, preferably 15 to 40, more preferably 20 to 40, most preferably 25 to 35.

Typically, the mass average molecular weight of additive a) is from 1000 g/ml to 10000 g/ml, preferably 2000 g/mol to 9000 g/mol. In case of embodiment PA-1, the mass average molecular weight of additive a) is typically from 4000 g/mol to 8000 g/mol, preferably from 5000 g/mol to 7000 g/mol, more preferably from 5500 g/mol to 6500 g/mol. In case of embodiment PA-2, the mass average molecular weight of polymer a) is typically from 5000 g/mol to 10000 g/mol, preferably from 6000 g/mol to 9000 g/mol, more preferably from 7000 g/mol to 9000 g/mol, and particularly preferably from 7500 g/mol to 8500 g/mol.

The agrochemical composition may comprise the adjuvant a) in a concentration of at least 1 wt %, preferably at least 3 wt %, more preferably at least 4 wt %, and particularly preferably at least 5 wt % based on the total weight of the agrochemical composition. The agrochemical composition may comprise the adjuvant a) in a concentration of up to 50 wt %, preferably up to 40 wt %, more preferably up to 30 wt %, most preferably up to 20 wt %, particularly preferably up to 10 wt %, and utmost preferably up to 5 wt % based on the total weigh to the agrochemical composition. The agrochemical composition may comprise the adjuvant a) in a concentration of from 1 to 25 wt %, preferably from 2 to 15 wt %, more preferably from 5 to 10 wt %, and particularly preferably from 4 to 6 wt %. Typically, adjuvant a) is completely dissolved in the agrochemical composition at 20° C.

Additive b) is a hyperbranched polycarbonate. By hyperbranched polymers for the purposes of this invention are meant non-crosslinked macromolecules having hydroxyl and carbonate or carbamoyl chloride groups, which may be both structurally and molecularly non-uniform. On the one hand, they may be synthesized starting from a central molecule in the same way as for dendrimers but, in contrast to the latter, with a nonuniform chain length of the branches. Hyperbranched polymers are therefore to be differentiated from dendrimers (U.S. Pat. No. 6,399,048). For the purposes of the present invention, hyperbranched polymers do not comprise dendrimers. On the other hand, the hyperbranched polymers may also be of linear construction, with functional, branched side groups, or else, as a combination of the two extremes, may include linear and branched molecule moieties. For the definition of dendrimers and hyperbranched polymers see also P. J. Flory, J. Am. Chem. Soc. 1952, 74, 2718 and H. Frey et al., Chem. Eur. J. 2000, 6, 2499.

By “hyperbranched” in the context of the present invention is meant that the degree of branching (DB), in other words the ratio of the sum of the average number of dendritic linkages plus the average number of end groups to the sum of the average number of dendritic and linear linkages plus the average number of end groups, per molecule, multiplied by 100, is 10% to 99.9%, preferably 20% to 99%, more preferably 20% to 95%. By “dendrimeric” in the context of the present invention is meant that the degree of branching is 99.9%-100%. For the definition of the degree of branching see H. Frey et al., Acta Polym. 1997, 48, 30.

It is an advantage of the present invention that the polymer b) is non-crosslinked. “Non-crosslinked” for the purposes of this specification means that the degree of crosslinking present is less than 15% by weight, preferably less than 10% by weight, determined via the insoluble fraction of the polymer. The insoluble fraction of the polymer was determined by four-hour extraction with the same solvent as used for the gel permeation chromatography for determining the molecular weight distribution of the polymers, i.e., tetrahydrofuran, dimethylacetamide or hexafluoroisopropanol, according to which solvent has the better solvency for the polymer, in a Soxhlet apparatus and, after drying of the residue to constant weight, by weighing of the residue remaining.

The hyperbranched polycarbonate is typically obtainable by
a) preparing a condensation product (K) by reacting an organic carbonate (E) or a phosgene derivative with an alcohol (F1) which has at least three hydroxyl groups, and
b) intermoleculariy converting K to the hyperbranched polycarbonate,
   the quantitative ratio of the OH groups to the carbonate or phosgene groups being selected such that K has an average of either i) one carbonate or carbamoyl chloride group and more than one OH group, or ii) one OH group and more than one carbonate or carbamoyl group. The polycarbonate is preferably obtained in this way.

The condensation product (K) can be prepared using an organic carbonate (E) or a phosgene derivative. Examples of suitable phosgene derivatives are phosgene, diphosgene or triphosgene, preferably phosgene. It is preferred to use an organic carbonate.

The radicals R³ in the organic carbonates (E) of the general formula R³O[(CO)O]ₒR³ that are used as starting material are each independently of one another a straight-chain or branched aliphatic, aromatic/aliphatic (araliphatic) or aromatic hydrocarbon radical having 1 to 20 C atoms. The two radicals R³ may also be joined to one another to form a ring. The two radicals R³ may be the same or different; they are preferably the same. The radical in question is preferably an aliphatic hydrocarbon radical and more preferably a straight-chain or branched alkyl radical having 1 to 5 C atoms, or a substituted or unsubstituted phenyl radical. R³ in this case is a straight-chain or branched, preferably straight-chain (cyclo)aliphatic, aromatic/aliphatic or aromatic, preferably (cyclo)aliphatic or aromatic, more preferably aliphatic hydrocarbon radical having 1 to 20 C atoms, preferably 1 to 12, more preferably 1 to 6, and very preferably 1 to 4 carbon atoms. Examples of such radicals are methyl, ethyl, isopropyl, n-propyl, n-butyl, isobutyl, sec-butyl, tert-butyl, n-hexyl, n-heptyl, n-octyl, n-decyl, n-dodecyl, n-tetradecyl, n-hexadecyl, noctadecyl, n-eicosyl, 2-ethylhexyl, cyclopentyl, cyclohexyl, cyclooctyl, cyclododecyl, phenyl, o- or p-tolyl or naphthyl. Methyl, ethyl, n-butyl, and phenyl are preferred. These radicals R³ may be the same or different; they are preferably the same. The radicals R³ may also be joined to one another to form a ring. Examples of divalent radicals R³ of this kind are 1,2-ethylene, 1,2-propylene, and 1,3-propylene. In general, the index o is an integer from 1 to 5, preferably from 1 to 3, more preferably from 1 to 2. The carbonates may preferably be simple carbonates of the general formula R³O(CO)OR³, i.e. the index o in this case is 1.

Examples of suitable carbonates comprise aliphatic, aromatic/aliphatic or aromatic carbonates such as ethylene carbonate, 1,2- or 1,3-propylene carbonate, diphenyl carbonate, ditolyl carbonate, dixylyl carbonate, dinaphthyl carbonate, ethyl phenyl carbonate, dibenzyl carbonate, dimethyl carbonate, diethyl carbonate, di-n-propyl carbonate, di-n-butyl carbonate, diisobutyl carbonate, dipentyl carbonate, dihexyl carbonate, dicyclohexyl carbonate, diheptyl carbonate, dioctyl carbonate, didecyl carbonate or didodecyl carbonate. Examples of carbonates in which n is greater than 1 comprise dialkyl dicarbonates, such as di-tert-butyl dicarbonate, or dialkyl tricarbonates such as di-tert-butyl tricarbonate. One preferred aromatic carbonate is diphenyl carbonate. Preference is given to aliphatic carbonates, more particularly those in which the radicals comprise 1 to 5 C atoms, such as dimethyl carbonate, diethyl carbonate, di-n-propyl carbonate, di-n-butyl carbonate or diisobutyl carbonate, for example. Diethyl carbonate is especially preferred.

The alcohol (F1) which has at least three hydroxyl groups is usually an aliphatic or aromatic alcohol, or a mixture or two or more different alcohols of this kind. The alcohol (F1) may be branched or unbranched, substituted or unsubstituted, and have 3 to 26 carbon atoms. It is preferably an aliphatic alcohol. Examples of compounds having at least three OH groups comprise glycerol, trimethylolmethane, trimethylolethane, trimethylolpropane, trimethylolbutane, 1,2,4-butanetriol, 1,2,3-hexanetriol, 1,2,4-hexanetriol, tris(hydroxymethyl)amine, tris(hydroxyethyl)amine, tris(hydroxypropyl)amine, pentaerythritol, diglycerol, triglycerol, polyglycerols, bis(trimethylolpropane), tris(hydroxymethyl) isocyanurate, tris(hydroxyethyl) isocyanurate, phloroglucinol, trihydroxytoluene, trihydroxydimethylbenzene, phloroglucides, hexahydroxybenzene, 1,3,5-benzenetrimethanol, 1,1,1-tris(4′-hydroxyphenyl)methane, 1,1,1-tris(4′-hydroxyphenyl)ethane, sugars, for example glucose, sugar derivatives, for example sorbitol, mannitol, diglycerol, threitol, erythritol, adonitol (ribitol), arabitol (lyxitol), xylitol, dulcitol (galactitol), maltitol, isomalt, or polyesterol. In addition, F1 may be a trifunctional or higher-functionality polyetherol based on alcohols which have at least three OH groups, and C₂-C₂₄ alkylene oxide. The polyetherol comprises usually one to 30, preferably one to 20, more preferably one to 10 and most preferably one to eight molecules of ethylene oxide and/or propylene oxide and/or isobutylene oxide per hydroxyl group. Preferably, the polyetherol is based on an alcohol with at least 3 OH groups and 1 to 30 molecules alkylene oxide, more preferably based on an alcohol with at least 3 OH groups and 5 to 20 molecules propylene oxide.

The hyperbranched polycarbonate preferably comprises an alcohol (F1) which is a trifunctional or higher-functionality polyetherol based on alcohols which have at least three OH groups, and C₃-C₂₄ alkylene oxide. Suitable alcohols which have at least three OH groups are as described above, preferably glycerol, trimethylolethane, trimethylolpropane, 1,2,4-butanetriol, 1,2,3-hexanetriol, 1,2,4-hexanetriol, pentaerythritol, more preferably glycerol or trimethylolpropane. Preferred C₃-C₂₄ alkylene oxides include propylene oxide, butylene oxide, pentylene oxide and mixtures thereof, more preferably propylene oxide. The trifunctional or higher-functionality poly-etherols usually comprise at least one to 30, preferably two to 30, more preferably three to 20 C₃-C₂₄ alkylene oxide molecules in polymerized form. A particularly preferred alcohol (F1) is a trifunctional polyetherol based on glycerol, trimethylolethane, trimethylolpropane, 1,2,4-butanetriol and/or pentaerythritol, and propylene oxide, where the polyetherol comprises at least three, preferably three to 30, more preferably three to 20, molecules of propylene oxide in polymerized form.

In addition to the alcohol (F1), the polycarbonate may have a difunctional alcohol (F2) as a forming component, with the proviso that the mean OH functionality of all alcohols F used together is greater than 2. The alcohols (F1) and (F2) are referred to here together as (F). Suitable difunctional alcohols F2 include diethylene glycol, triethylene glycol, 1,2- and 1,3-propanediol, dipropylene glycol, tripropylene glycol, neopentyl glycol, 1,2-, 1,3- and 1,4-butanediol, 1,2-, 1,3- and 1,5-pentanediol, 1,6-hexanediol, 1,2- or 1,3-cyclopentanediol, 1,2-, 1,3- or 1,4-cyclohexanediol, 1,1-, 1,2-, 1,3- or 1,4-cyclohexanedimethanol, bis(4-hydroxycyclohexyl)methane, bis(4-hydroxycycohexyl)ethane, 2,2-bis(4-hydroxycyclohexyl)propane, 1,1′-bis(4-hydroxyphenyl)-3,3,5-trimethylcyclohexane, resorcinol, hydroquinone, 4,4′-dihydroxybiphenyl, bis(4-hydroxyphenyl) sulfide, bis(4-hydroxyphenyl) sulfone, bis(hydroxymethyl)benzene, bis(hydroxymethyl)toluene, bis(p-hydroxyphenyl)methane, bis(p-hydroxyphenyl)ethane, 2,2-bis(p-hydroxyphenyl)propane, 1,1-bis(phydroxyphenyl)cyclohexane, dihydroxybenzophenone, difunctional polyetherpolyols based on ethylene oxide, propylene oxide, butylene oxide or mixtures thereof, polytetrahydrofuran having a molar mass of 162 to 2000, polycaprolactone or polyesterols based on diols and dicarboxylic acids. Preferred difunctional alcohols (F2) are difunctional polyetherpolyols based on ethylene oxide, propylene oxide, butylene oxide or mixtures thereof, and polyesterols based on diols and dicarboxylic acids.

The diols serve for fine adjustment of the properties of the polycarbonate. If difunctional alcohols are used, the ratio of difunctional alcohols (F2) to the at least trifunctional alcohols (F1) is fixed by the person skilled in the art according to the desired properties of the polycarbonate. In general, the amount of the alcohol(s) (F2) is 0 to 50 mol % based on the total weight of all alcohols (F1) and (F2) together. The amount is preferably 0 to 35 mol %, more preferably 0 to 25 mol % and most preferably 0 to 10 mol %.

The reaction of phosgene, diphosgene or triphosgene with the alcohol or alcohol mixture is generally effected with elimination of hydrogen chloride; the reaction of the carbonates with the alcohol or alcohol mixture to give the inventive high-functionality highly branched polycarbonate is effected with elimination of the monofunctional alcohol or phenol from the carbonate molecule.

After this reaction, i.e. without any further modification, the hyperbranched polycarbonate has high-functionality termination with hydroxyl groups and with carbonate groups or carbamoyl chloride groups. A high-functionality polycarbonate is understood in the context of this invention to mean a product which, as well as the carbonate groups which form the polymer skeleton, additionally has, in terminal or lateral position, at least three, preferably at least four and more preferably at least six functional groups. The functional groups are carbonate groups or carbamoyl chloride groups and/or OH groups. There is in principle no upper limit in the number of terminal or lateral functional groups, but products with a very high number of functional groups may have undesired properties, for example high viscosity or poor solubility. The high-functionality polycarbonates of the present invention usually have not more than 500 terminal or lateral functional groups, preferably not more than 100 terminal or lateral functional groups.

In the preparation of the high-functionality polycarbonates, it is necessary to adjust the ratio of the compounds comprising OH groups to phosgene or carbonate (A) such that the resulting simplest condensation product (known hereinafter as condensation product (K)) comprises an average of either i) one carbonate or carbamoyl chloride group and more than one OH group or ii) one OH group and more than one carbonate or carbamoyl chloride group, preferably an average of either i) one carbonate or carbamoyl chloride group and at least two OH groups or ii) one OH group and at least two carbonate or carbamoyl chloride groups.

It may additionally be advisable, for fine adjustment of the properties of the polycarbonate, to use at least one difunctional carbonyl-reactive compound (E1). This is understood to mean those compounds which have two carbonate and/or carboxyl groups. Carboxyl groups may be carboxylic acids, carbonyl chlorides, carboxylic anhydrides or carboxylic esters, preferably carboxylic anhydrides or carboxylic esters and more preferably carboxylic esters. If such difunctional compounds (E1) are used, the ratio of (E1) to the carbonates or phosgenes (E) is fixed by the person skilled in the art according to the desired properties of the polycarbonate. In general, the amount of the difunctional compound(s) (E1) is 0 to 40 mol % based on the total weight of all carbonates/phosgenes (E) and compounds (E1) together. Preferably the amount is 0 to 35 mol %, more preferably 0 to 25 mol %, and very preferably 0 to 10 mol %. Examples of compounds (E1) are dicarbonates or dicarbamoyl chlorides of diols, examples of which are ethylene glycol, 1,2-propanediol, 1,3-propanediol, 1,1-dimethylethane-1,2-diol, 2-butyl-2-ethyl-1,3-propanediol, 2-ethyl-1,3-propanediol, 2-methyl-1,3-propanediol, neopentyl glycol, neopentyl glycol hydroxypivalate, 1,2-, 1,3- or 1,4-butanediol, 1,6-hexanediol, 1,10-decanediol, bis(4-hydroxycyclohexane)isopropylidene, tetramethylcyclobutanediol, 1,2-, 1,3- or 1,4-cyclohexanediol, cyclooctanediol, norbomanediol, pinanediol, decalindiol, 2-ethyl-1,3-hexanediol, 2,4-diethyloctane-1,3-diol, hydroquinone, bisphenol A, bisphenol F, bisphenol B, bisphenol S, 2,2-bis(4-hydroxycyclohexyl)propane, 1,1-, 1,2-, 1,3- and 1,4-cyclohexanedimethanol, and 1,2-, 1,3- or 1,4-cycohexanediol. These compounds may be prepared, for example, by reacting said diols with an excess of, for example, the above-recited carbonates R³O(CO)OR³ or chlorocarbonic esters, so that the dicarbonates thus obtained are substituted on both sides by groups R³O(CO)—. A further possibility is to react the diols first with phosgene to give the corresponding chlorocarbonic esters of the diols, and then to react these esters with alcohols.

Further compounds (E1) are dicarboxylic acids, esters of dicarboxylic acids, preferably the methyl, ethyl, isopropyl, n-propyl, n-butyl, isobutyl, sec-butyl or tert-butyl esters, more preferably the methyl, ethyl or n-butyl esters. Examples of dicarboxylic acids of this kind are oxalic acid, maleic acid, fumaric acid, succinic acid, glutaric acid, adipic acid, sebacic acid, dodecanedioic acid, o-phthalic acid, isophthalic acid, terephthalic acid, azelaic acid, 1,4-cyclohexanedicarboxylic acid or tetrahydrophthalic acid, suberic acid, phthalic anhydride, tetrahydrophthalic anhydride, hexahydrophthalic anhydride, tetrachlorophthalic anhydride, endomethylenetetrahydrophthalic anhydride, glutaric anhydride, dimeric fatty acids, isomers thereof and hydrogenation products thereof.

The simplest structure of the condensation product (K), illustrated using, as example, the reaction of a carbonate (E) with a dialcohol or polyalcohol (F), produces the arrangement XY_{q} or Y_{q}X, wherein X is a carbonate or carbamoyl group, Y is a hydroxyl group, and the index q generally is an integer greater than 1 to 6, preferably greater than 1 to 4, more preferably greater than 1 to 3. The reactive group, which results as a single group, is generally referred to below as “focal group”.

Where, for example, in the preparation of the simplest condensation product (K) from a carbonate and a dihydric alcohol, the molar reaction ratio is 1:1, then the result on average is a molecule of type XY, illustrated by the general formula (II).

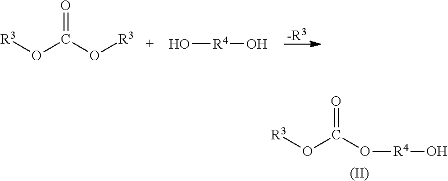

In the case of the preparation of the condensation product (K) from a carbonate and a trihydric alcohol with a molar reaction ratio of 1:1, the result on average is a molecule of type XY₂, illustrated by the general formula (III). The focal group here is a carbonate group.

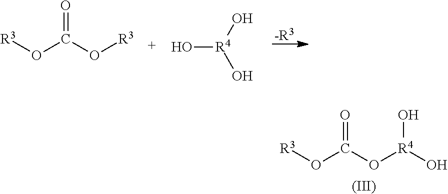

In the preparation of the condensation product (K) from a carbonate and a tetrahydric alcohol, again with the molar reaction ratio 1:1, the result on average is a molecule of type XY₃, illustrated by the general formula (IV). The focal group here is a carbonate group.

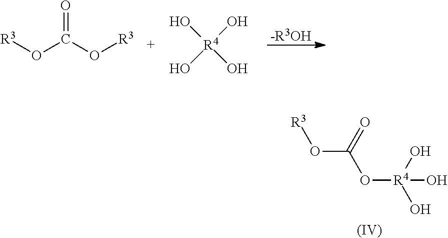

In the formulae (II) to (IV) R³ is as defined for the organic carbonate (E), and R⁴ is an aliphatic or aromatic radical.

The condensation product (K) can also be prepared, for example, from a carbonate and a trihydric alcohol, illustrated by the general formula (V), where the reaction ratio on a molar basis is 2:1. Here the result on average is a molecule of type X₂Y, the focal group here being an OH group. In the formula (V) the definitions of R³ and R⁴ are the same as above in formulae (II) to (IV).

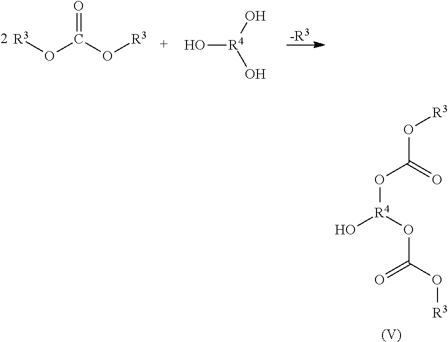

If difunctional compounds, e.g., a dicarbonate or a diol, are additionally added to the components, this produces an extension of the chains, as illustrated for example in the general formula (VI). The results again is on average a molecule of type XY₂, the focal group being a carbonate group.

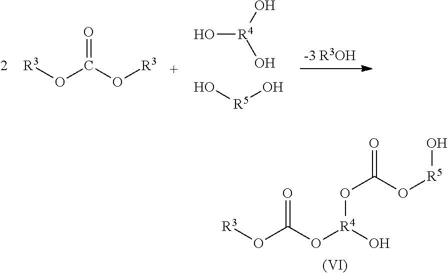

In formula (VI) R⁵ is an aliphatic or aromatic radical while R³ and R⁴ are defined as described above.

It is also possible to use two or more condensation products (K) for the synthesis. In this case, it is possible on the one hand to use two or more alcohols and/or two or more carbonates. Furthermore, through the choice of the ratio of the alcohols and carbonates or phosgenes used, it is possible to obtain mixtures of different condensation products with different structure. This may be exemplified taking, as example, the reaction of a carbonate with a trihydric alcohol. If the starting products are used in a 1:1 ratio, as depicted in (Ill), a molecule XY₂ is obtained. If the starting products are used in a 2:1 ratio, as illustrated in (V), the result is a molecule X₂Y. With a ratio between 1:1 and 2:1 a mixture of molecules XY₂ and X₂Y is obtained.

The stoichiometry of components (E) and (F) is generally chosen such that the resultant condensation product (K) contains either one carbonate or carbamoyl chloride group and more than one OH group, or one OH group and more than one carbonate or carbamoyl chloride group. This is achieved in the first case by a stoichiometry of 1 mol of carbonate groups: >2 mol of OH groups, for example, a stoichiometry of 1:2.1 to 8, preferably 1:2.2 to 6, more preferably 1:2.5 to 4, and very preferably 1:2.8 to 3.5. In the second case it is achieved by a stoichiometry of more than 1 mol of carbonate groups: <1 mol of OH groups, for example, a stoichiometry of 1:0.1 to 0.48, preferably 1:0.15 to 0.45, more preferably 1:0.25 to 0.4, and very preferably 1:0.28 to 0.35.

The preparation of additive b) is described in WO20101130599, particularly preferably p.13, I.5 to p.16, I.25 and the Synthesis Examples.

The hyperbranched polycarbonate generally has a glass transition temperature of less than 50° C., preferably less than 30° C. and more preferably less than 10° C. The OH number is usually at least 30 mg KOH/g, preferably between 50 and 250 mg/g. The mass average molar weight M_{w} is usually between 1000 and 150 000, preferably from 1500 to 100 000 g/mol, the number average molar weight Mₙ between 500 and 50 000, preferably between 1000 and 40 000 g/mol.

The hyperbranched polycarbonate is connected to a linear polymer comprising polyethylene glycol. Examples of polyethylene glycol are polyethylene glycol or polyethylene glycol monoalkyl ethers having a number average molar mass Mₙ of 200 to 10000 g/mol, preferably 300-2000 g/mol. The polyethylene glycol is preferably a polyethyleneglycol mono-C₁-C₁₈-alkyl ether, especially a polyethylene glycol monomethyl ether. The molar ratio of hyperbranched polycarbonate to linear polymer is usually in the range from 1:1 to 1:100, preferably 1:1 to 1:50, more preferably 1:1 to 1:25.

Typically, the linear polymer is joined to the polycarbonate via a linker. Suitable functionalizing reagents for covalent joining by means of a linker are hydroxycarboxylic acids, aminocarboxylic acids, hydroxysulfonic acids, hydroxysulfates, aminosulfonic acids or aminosulfates, hydroxylamines (such as diethanolamine), polyamines (e.g. diethylenetetramine) or polyols (e.g. glycerol, trimethylolpropane, pentaerythritol). Preferred linkers for this purpose are polyisocyanates described below, preferably diisocyanates, more preferably aliphatic diisocyanates (such as hexamethylene diisocyanate and isophorone diisocyanate).

Preferred diisocyanates are aliphatic diisocyanates (such as hexamethylene diisocyanate and isophorone diisocyanate). Usually, the linker is first bonded covalently to a terminal OH-group of the linear polymer, in order then to couple the linker-containing polymer onto the hyperbranched polycarbonate. The reaction of the linear polymer with a diisocyanate is described in WO2010/130599, p.23, I.33 to p.24, I.42.

Alternatively, the linear polymer may be generated by direct alkoxylation of the polycarbonate, as described in WO2011069895. The direct alkoxylation may be carried out by reaction with ethylene oxide or a mixture of ethylene oxide and C₃-C₅ alkylene oxide. If the alcohol (F1) is higher-functionality polyetherol based on alcohols which have at least three OH groups, and C₅-C₂₄ alkylene oxide, the weight ratio of the oligo- or polymerized C₃-C₂₄ alkylene oxide plus the C₃-C₅ alkylene oxide, relative to the ethylene oxide is from 3:1 to 1:3.

The molar ratio of hyperbranched polycarbonate to linear polymer is 1:1 to 1:25, preferably 1:2 to 1:15. The reaction is continued until the isocyanate value has fallen to zero.

Adjuvants a) and b) contain certain monomers in polymerized form. Although trace amounts of unreacted monomers may still be present in the polymers, they are essentially free of monomers. Throughout this specification, the terms “contains monomers [x] in polymerized form” and “contains monomers [x]” have the same meaning.

The agrochemical composition may comprise the adjuvant b) in a concentration of at least 0.5 wt %, preferably at least 1 wt %, more preferably at least 2 wt % based on the total weight of the agrochemical composition. The agrochemical composition may comprise the adjuvant b) in a concentration of up to 30 wt %, preferably up to 25 wt %, more preferably up to 20 wt %, most preferably up to 18 wt %, and particularly preferably up to 17.5 wt % based on the total weigh to the agrochemical composition. The agrochemical composition may comprise the adjuvant b) in a concentration of from 0.5 to 25 wt %, preferably from 1 to 25 wt %, more preferably from 1 to 20 wt %, most preferably from 2 to 20 wt % based on the total weight of the agrochemical composition.

The agrochemical composition may comprise the adjuvant b) in a concentration of at least 5 g/l, preferably at least 10 g/l, more preferably at least 25 g/l. The agrochemical composition may comprise the adjuvant b) in a concentration of up to 350 g/A, preferably up to 300 g/A, more preferably up to 250 g/l. The agrochemical composition may comprise the adjuvant b) in a concentration of from 1 to 350 g/l, preferably from 5 to 250 g/l, more preferably from 25 to 250 g/l.

If no other adjuvant a) or c) is present in the agrochemical composition, the concentration of adjuvant b) is typically at least 10 wt %, preferably at least 11 wt %, more preferably at least 12 wt % based on the total weight of the agrochemical composition.

If no other adjuvant a) or c) is present in the agrochemical composition, the concentration of adjuvant b) is typically from 10 to 40 wt %, more preferably from 11 to 20 wt %, most preferably from 11 to 18 wt % based on the total weight of the agrochemical composition.

Accordingly, if no other adjuvant a) or c) is present in the agrochemical composition, the concentration of adjuvant b) is typically at least 120 g/A, preferably at least 150 g/A, more preferably at least 180 g/l. If no other adjuvant a) or c) is present in the agrochemical composition, the concentration of adjuvant b) is typically from 120 to 250 g/l, preferably from 150 to 200 g/l.

Typically, adjuvant b) is completely dissolved in the agrochemical composition at 20° C.

Adjuvant c) is a solvent selected from C₁-C₆-alkyl lactate, C₃-C₆-lactone, and N—C₁-C₁₅-alkyl pyrrolidone.

In one embodiment, the agrochemical composition comprises a solvent selected from C₁-C₆-alkyl lactates, preferably a C₁-C₆-alkyl lactates, more preferably ethyl lactate or n-propyl lactate.

In one embodiment, the solvent is selected from methyl lactate, ethyl lactate, propyl lactate, butyl lactate, pentyl lactate, and hexyl lactate. In another embodiment, the solvent is ethyl lactate. In another embodiment, the solvent is n-propyl lactate. In another embodiment, the solvent is methyl lactate. In another embodiment, the solvent is pentyl lactate. In another embodiment, the solvent is hexyl lactate.

In another embodiment, the adjuvant composition comprises a solvent selected from N—C₁-C₁₅-alkyl pyrrolidones, preferably N—C₄-C₁₂-alkyl pyrrolidones. In one embodiment, the solvent is N-methyl pyrrolidone, N-ethyl pyrrolidone, N-propyl pyrrolidone, N-butyl pyrrolidone, N-pentyl pyrrolidone, N-hexyl pyrrolidone, N-heptyl pyrrolidone, N-octyl pyrrolidone, N-nonyl pyrrolidone, N-decyl pyrrolidone, N-undecyl pyrrolidone, N-dodecyl pyrrolidone, N-tridecyl pyrrolidone, N-tetradecyl pyrrolidone, or N-pentadecyl pyrrolidone. In one embodiment, the solvent is N-butyl pyrrolidone, N-octyl pyrrolidone, or N-dodecyl pyrrolidone. In another embodiment, the solvent is N-butyl pyrrolidone. In another embodiment, the solvent is N-octyl pyrrolidone. In yet another embodiment, the solvent is N-dodecyl pyrrolidone. In yet another embodiment, the solvent is N-butyl pyrrolidone or N-octyl pyrrolidone.

In another embodiment, the agrochemical composition comprises a solvent selected from C₃-C₆-lactones, preferably C₄-C₆-lactones. In one embodiment, the solvent is gamma-butyrolactone. In another embodiment, the solvent is epsilon-caprolactone. In another embodiment, the solvent is beta-propiolactone.

The agrochemical composition may comprise the additive c) in a concentration of at least 1 wt %, preferably at least 1.5 wt %, more preferably at least 2 wt % based on the total weight of the agrochemical composition. The agrochemical composition may comprise the additive c) in a concentration of up to 30 wt %, preferably up to 25 wt %, more preferably up to 20 wt %, most preferably up to 18 wt %, and particularly preferably up to 16 wt % based on the total weigh to the agrochemical composition. The agrochemical composition may comprise the additive c) in a concentration of from 1 to 25 wt %, preferably from 1 to 20 wt %, more preferably from 1 to 18 wt %, and particularly preferably from 2 to 17 wt %.

If no other adjuvant a) or b) is present in the agrochemical composition, the concentration of adjuvant c) is typically at least 5 wt %, preferably at least 6 wt %, more preferably at least 10, most preferably at least 12 wt % based on the total weight of the agrochemical composition.

If no other adjuvant a) or b) is present in the agrochemical composition, the concentration of adjuvant c) is typically from 5 to 40 wt %, more preferably from 6 to 20 wt %, most preferably from 10 to 18 wt % based on the total weight of the agrochemical composition.

Accordingly, if no other adjuvant a) or b) is present in the agrochemical composition, the concentration of adjuvant b) is typically at least 50 g/l, preferably at least 80 g/l, more preferably at least 150 g/l, most preferably at least 180 g/l. If no other adjuvant a) or c) is present in the agrochemical composition, the concentration of adjuvant b) is typically from 50 to 250 g/l, preferably from 150 to 200 g/l.

If adjuvant c) is N—C₁-C₁₅-alkyl pyrrolidone, preferably N-propyl pyrrolidone, the concentration of adjuvant c) is typically at least 10 g/l, preferably at least 20 g/l, more preferably at least 25 g/l, most preferably at least 50 g/l, utmost preferably at least 80 g/l; and the concentration is of adjuvant c) is up to 300 g/A, preferably up to 250 g/A, more preferably up to 200 g/l.

Accordingly, if adjuvant c) is N—C₁-C₁₅-alkyl pyrrolidone, preferably N-propyl pyrrolidone, the concentration of adjuvant c) is typically at least 1 wt %, preferably at least 2 wt %, more preferably at least 5 wt %, most preferably at least 7.5 wt % based on the total weight of the agrochemical composition; and the concentration is of adjuvant c) is up to 25 wt %, preferably up to 20 wt %, more preferably up to 16 wt % based on the total weight of the agrochemical composition.

If adjuvant c) is C₃-C₆-lactone, preferably gamma butyrolactone, the concentration of adjuvant c) is typically at least 10 g/l, preferably at least 20 g/l, more preferably at least 25 g/l, most preferably at least 50 g/A, utmost preferably at least 80 g/l; and the concentration is of adjuvant c) is up to 300 g/l, preferably up to 250 g/A, more preferably up to 200 g/A. In one embodiment, the agrochemical composition does not contain gamma butyrolactone. In another embodiment, the agrochemical composition comprises gamma butyrolactone in a concentration of up to 80 g/l, preferably up to 50 g/l, most preferably up to 10 g/l, and in particular up to 1 g/l.

Accordingly, if adjuvant c) is N—C₁-C₁₅-alkyl pyrrolidone, preferably N-propyl pyrrolidone, the concentration of adjuvant c) is typically at least 1 wt %, preferably at least 2 wt %, more preferably at least 5 wt % based on the total weight of the agrochemical composition; and the concentration is of adjuvant c) is up to 25 wt %, preferably up to 20 wt %, more preferably up to 16 wt % based on the total weight of the agrochemical composition.

The agrochemical composition comprises at least one of additives a), b) or c). The agrochemical composition may also contain a mixture of two or three of additives a), b), and c).

In one embodiment, the agrochemical composition comprises dicamba-K, C₁-C₆-alkyl lactate, and additive a). In another embodiment, the agrochemical composition comprises dicamba-K, ethyl lactate, and additive a), preferably wherein polymer a) is as defined in embodiments PA-1 or PA-2, more preferably wherein polymer a) is as defined in embodiment PA-2. In another embodiment, the agrochemical composition comprises dicamba-K, n-propyl lactate, and additive a), preferably wherein polymer a) is as defined in embodiments PA-1 or PA-2, more preferably wherein polymer a) is as defined in embodiment PA-2.

In one embodiment, the agrochemical composition comprises dicamba-K, N—C₁-C₁₅-alkyl pyrrolidone, and additive a). In another embodiment, the agrochemical composition comprises dicamba-K, N-octyl pyrrolidone, and additive a), preferably wherein additive a) is as defined in embodiments PA-1 or PA-2, more preferably wherein additive a) is as defined in embodiment PA-2. In another embodiment, the agrochemical composition comprises dicamba-K, N-butyl pyrrolidone, and additive a), preferably wherein additive a) is as defined in embodiments PA-1 or PA-2, more preferably wherein additive a) is as defined in embodiment PA-2. In another embodiment, the agrochemical composition comprises dicamba-K, N-dodecyl pyrrolidone, and additive a), preferably wherein additive a) is as defined in embodiments PA-1 or PA-2, more preferably wherein additive a) is as defined in embodiment PA-2.

In one embodiment, the agrochemical composition comprises dicamba-K, C₁-C₆-lactone, and additive a). In another embodiment, the agrochemical composition comprises dicamba-K, gamma-butyrolactone, and additive a), preferably wherein additive a) is as defined in embodiments PA-1 or PA-2, more preferably wherein additive a) is as defined in embodiment PA-2. In another embodiment, the agrochemical composition comprises dicamba-K, epsilon-caprolactone, and additive a), preferably wherein additive a) is as defined in embodiments PA-1 or PA-2, more preferably wherein additive a) is as defined in embodiment PA-2.

In one embodiment, the agrochemical composition comprises dicamba-K, C₁-C₁₅-alkyl lactate, and additive b). In another embodiment, the agrochemical composition comprises dicamba-K, ethyl lactate, and additive b), wherein additive b) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive b) a hyperbranched polycarbonate connected to polyethylene glycol monomethyl ether via a linker.

In another embodiment, the agrochemical composition comprises dicamba-K, n-propyl lactate, and additive b), wherein additive b) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive b) a hyperbranched polycarbonate connected to polyethylene glycol monomethyl ether via a linker.

In one embodiment, the agrochemical composition comprises dicamba-K, N—C₁-C₁₅-alkyl pyrrolidone, and additive b). In another embodiment, the agrochemical composition comprises dicamba-K, N-octyl pyrrolidone, and additive b), wherein additive b) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive b) a hyperbranched polycarbonate connected to polyethylene glycol monomethyl ether via a linker.

In another embodiment, the agrochemical composition comprises dicamba-K, N-butyl pyrrolidone, and additive b), wherein additive b) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive b) a hyperbranched polycarbonate connected to polyethylene glycol monomethyl ether via a linker.

In another embodiment, the agrochemical composition comprises dicamba-K, N-dodecyl pyrrolidone, and additive b), wherein additive b) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive b) a hyperbranched polycarbonate connected to polyethylene glycol monomethyl ether via a linker.

In another embodiment, the agrochemical composition comprises dicamba-K, C₃-C₆-lactone, and additive b), wherein additive b) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive b) a hyperbranched polycarbonate connected to polyethylene glycol monomethyl ether via a linker.

In another embodiment, the agrochemical composition comprises dicamba-K, gamma-butyrolactone, and additive b), wherein additive b) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive b) a hyperbranched polycarbonate connected to polyethylene glycol monomethyl ether via a linker.

If additive c) is present in the agrochemical formulation, either as the only additive a), b), or c), or as a mixture with one of the other additives a) or b), the additive c) may comprise one of the solvents selected from C₁-C₆-alkyl lactate, C₃-C₆-lactone and N—C₁-C₁₅-alkyl pyrrolidone, or it may comprise a mixture thereof. Typically, additive c) may be a mixture of C₃-C₆-lactone and either C₁-C₆-alkyl lactate or N—C₁-C₁₅-alkyl pyrrolidone, preferably of gamma butyrolactone with C₁-C₆-alkyl lactate or N—C₁-C₁₅-alkyl pyrrolidone.

The weight ratio of the C₃-C₆-lactone to the sum of C₁-C₆-alkyl lactate and N—C₁-C₁₅-alkyl pyrrolidone may be from 5:1 to 1:5, preferably from 1:1 to 1:3.

The total concentration of the sum of all adjuvants a), b) and c) is typically at least 80 g/l, preferably at least 100 g/l, more preferably at least 110 g/l. The total concentration of the sum of all adjuvants a), b) and c) may be up to 400 g/l, preferably up to 250 g/l, more preferably up to 230 g/l. Accordingly, the total concentration of the sum of all adjuvants a), b) and c) is typically at least 5 wt %, preferably at least 7.5 wt %, more preferably at least 10 wt % based on the total weight of the agrochemical composition. The total concentration of the sum of all adjuvants a), b) and c) may be up to 35 wt %, preferably up to 30 wt %, more preferably up to 20 wt %, most preferably up to 17.5 wt % based on the total weight of the agrochemical composition.

The weight ratio of adjuvant b) to adjuvant c) is typically from 20:1 to 1:20, preferably from 10:1 to 1:10, more preferably from 8:1 to 1:8.

The weight ratio of adjuvant a) to adjuvant c) is typically 20:1 to 1:20, preferably from 10:1 to 1:10, more preferably from 5:1 to 1:5, most preferably from 2:1 to 1:3.

The agrochemical composition may comprise a co-solvent. Suitable co-solvents are water-miscible up to at least a ratio of the co-solvent to water of 1:1, preferably at least 2:1, more preferably at least 4:1.

Suitable co-solvents are alcohols, e.g. ethanol, propanol, butanol, benzyl alcohol, cyclohexanol; glycols; DMSO; ketones, e.g. heptanone, cyclohexanone; esters, e.g. carbonates, fatty acid esters, fatty acids; phosphonates; amines; amides, e.g. fatty acid dimethylamides; and mixtures thereof.

The concentration of the co-solvent in the agrochemical formulation may be at least 1 wt %, preferably at least 2 wt %, more preferably at least 4 wt %, most preferably at least 5 wt %, based on the total weight of the agrochemical composition. The concentration of the co-solvent in the agrochemical formulation may be from 1 to 20 wt %, preferably from 1 to 10 wt %, more preferably from 2 to 8 wt %, most preferably from 4 to 7 wt % The agrochemical composition may comprise a further pesticide. The term pesticide refers to at least one active substance selected from the group of fungicides, insecticides, nematicides, herbicides, safeners, biopesticides and/or growth regulators. In one embodiment, the pesticide is an insecticide. In another embodiment, the pesticide is a fungicide. In yet another embodiment the pesticide is a herbicide. The skilled worker is familiar with such pesticides, which can be found, for example, in the Pesticide Manual, 16th Ed. (2013), The British Crop Protection Council, London. Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, METI acarizides, and insecticides such as chloropicrin, pymetrozin, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, rotenone, or their derivatives. Suitable fungicides are fungicides from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperdines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas. Examples of herbicides are glyphosate, glufosinate, paraquat, diquat, imazamox, 2,4-dichlorophenoxyacetic acid, aminopyralid, clopyralid, fluroxypyr, imazapyr, imazapic, triclopyr, and pyroxasulfone. In one embodiment, the pesticide is glyphosate. In yet another embodiment the pesticide is 2,4-dichlorophenoxyacetic acid. In yet another embodiment, the pesticide is pyroxasulfone. In yet another embodiment the pesticide is imazamox. In yet another embodiment, the pesticide is selected from glyphosate, glufosinate, paraquat, diquat, imazamox, 2,4-dichlorophenoxyacetic acid. In yet another embodiment, the pesticide is selected from glyphosate, glufosinate, imazamox, 2,4-dichlorophenoxyacetic acid. In yet another embodiment, the pesticide is selected from glyphosate, glufosinate, and a mixture thereof. Typically, the further pesticide has a water-solubility at 20° C. of at least 10 g/l, preferably at least 50 g/A.

The agrochemical composition may comprise the further pesticide in a concentration of at least 10 wt %, preferably at least 20 wt % more preferably at least 30 wt %, more preferably at least 40 wt %, most preferably at least 50 wt %, based on the total weight of the agrochemical composition. The agrochemical composition may comprise the further pesticide in an amount of from 10 to 90 wt %, preferably from 20 to 80 wt %, more preferably from 30 to 70 wt %, based on the total weight of the agrochemical composition.

The ratio of dicamba-K to the further pesticide may be from 10:1 to 1:10, preferably from 5:1 to 1:5, more preferably from 2:1 to 1:2. The ratio of dicamba-K to the further pesticide may be at least 1:1, preferably at least 3:1, more preferably 4:1.

The agrochemical composition is prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

The agrochemical composition is produced by contacting dicamba-K with the additive. The contacting may be carried out by mixing, shaking, homogenizing etc. Typically, the contacting is carried out in the presence of water.

The agrochemical composition may further comprise auxiliaries. Suitable auxiliaries are, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, non-ionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignin sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable non-ionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides.

Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide.

Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of dicamba-K on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), inorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin. Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

Various types of oils, wetters, adjuvants, fertilizer, or micronutrients, and further pesticides (e.g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

According to one embodiment, individual components of the composition according to the invention such as parts of a kit or parts of a binary or ternary mixture may be mixed by the user himself in a spray tank and further auxiliaries may be added, if appropriate.

In a further embodiment, either individual components of the composition according to the invention or partially premixed components, e.g. components comprising dicamba-K and/or the solvent and/or the polymer, may be mixed by the user in a spray tank and further auxiliaries and additives may be added, if appropriate. In a further embodiment, either individual components of the agrochemical composition or partially premixed components, e. g. components comprising dicamba-K and/or the solvent and/or the polymer, can be applied jointly (e.g. after tank mix) or consecutively.

The invention also relates to a method of controlling undesired vegetation, and/or for regulating the growth of plants, wherein the agrochemical composition is allowed to act on the respective pests, their environment, or the crop plants to be protected from the respective pest, on the soil and/or on the crop plants and/or on their environment.

If undesired vegetation is controlled, the agrochemical composition is usually applied on the crop plants to be protected from the undesired vegetation, on the soil and/or on the crop plants and/or on their environment. In one embodiment, the agrochemical composition is applied to the soil. In another embodiment, the agrochemical composition is applied to the foliage.

When employed in plant protection, the amounts of pesticide applied are, depending on the kind of effect desired, from 0.001 to 2 kg per ha, preferably from 0.005 to 2 kg per ha, more preferably from 0.05 to 0.9 kg per ha, in particular from 0.1 to 0.75 kg per ha.

Depending on the application method in question, the agrochemical composition can be employed in crop plants for eliminating undesired vegetation. Examples of suitable crop plants are the following:

Allium cepa, Ananas comosus, Arachis hypogaea, Asparagus officinalis, Avena sativa, Beta vulgans spec. altissima, Beta vulgans spec. rapa, Brassica napus var. napus, Brassica napus var. napobrassica, Brassica rapa var. silvestris, Brassica oleracea, Brassica nigra, Camellia sinensis, Carthamus tinctonus, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N.rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays. Especially preferred crops are crops of cereals, corn, soybeans, rice, oilseed rape, cotton, potatoes, peanuts or permanent crops.

The compositions according to the invention can also be used in genetically modified crop plants. The term “crops” as used herein thus includes also genetically modified crop plants which have been modified by mutagenesis or genetic engineering in order to provide a new trait to a plant or to modify an already present trait. The term “genetically modified crop plants” is to be understood as plants whose genetic material has been modified by the use of recombinant DNA techniques to include an inserted sequence of DNA that is not native to that crop plant species' genome or to exhibit a deletion of DNA that was native to that species' genome, wherein the modification(s) cannot readily be obtained by cross breeding, mutagenesis or natural recombination alone. Often, a particular genetically modified crop plant will be one that has obtained its genetic modification(s) by inheritance through a natural breeding or propagation process from an ancestral crop plant whose genome was the one directly treated by use of a recombinant DNA technique. Typically, one or more genes have been integrated into the genetic material of a genetically modified crop plant in order to improve certain properties of the crop plant. Such genetic modifications also include but are not limited to targeted post-translational modification of protein(s), oligo- or polypeptides. e. g., by inclusion therein of amino acid mutation(s) that permit, decrease, or promote glycosylation or polymer additions such as prenylation, acetylation famesylation, or PEG moiety attachment.

Mutagenesis includes techniques of random mutagenesis using X-rays or mutagenic chemicals, but also techniques of targeted mutagenesis, in order to create mutations at a specific locus of a plant genome. Targeted mutagenesis techniques frequently use oligonucleotides or proteins like CRISPR/Cas, zinc-finger nucleases, TALENs or meganucleases to achieve the targeting effect.

Genetic engineering usually uses recombinant DNA techniques to create modifications in a plant genome which under natural circumstances cannot readily be obtained by cross breeding, mutagenesis or natural recombination. Typically, one or more genes are integrated into the genome of a plant in order to add a trait or improve a trait. These integrated genes are also referred to as transgenes in the art, while plant comprising such transgenes are referred to as transgenic plants. The process of plant transformation usually produces several transformation events, which differ in the genomic locus in which a transgene has been integrated. Plants comprising a specific transgene on a specific genomic locus are usually described as comprising a specific “event”, which is referred to by a specific event name. Traits which have been introduced in plants or have been modified include in particular herbicide tolerance, insect resistance, increased yield and tolerance to abiotic conditions, like drought.

Herbicide tolerance has been created by using mutagenesis as well as using genetic engineering. Plants which have been rendered tolerant to acetolactate synthase (ALS) inhibitor herbicides by conventional methods of mutagenesis and breeding comprise plant varieties commercially available under the name Clearfield®. Several crop plants have been rendered tolerant to herbicides by mutagenesis and conventional methods of breeding, e. g., Clearfield® summer rape (Canola, BASF SE, Germany) being tolerant to imidazolinones, e. g., imazamox, or ExpressSun® sunflowers (DuPont, USA) being tolerant to sulfonyl ureas, e. g., tribenuron. Genetic engineering methods have been used to render crop plants such as soybean, cotton, corn, beets and rape, tolerant to herbicides such as glyphosate, imidazolinones and glufosinate, some of which are under development or commercially available under the brands or trade names RoundupReady® (glyphosate tolerant, Monsanto, USA), Cultivance® (imidazolinone tolerant, BASF SE, Germany) and LibertyLink® (glufosinate tolerant, Bayer CropScience, Germany). However, most of the herbicide tolerance traits have been created via the use of transgenes.

Herbicide tolerance has been created to glyphosate, glufosinate, 2,4-D, dicamba, oxynil herbicides, like bromoxynil and ioxynil, sulfonylurea herbicides, ALS inhibitor herbicides and 4-hydroxyphenylpyruvate dioxygenase (HPPD) inhibitors, like isoxaflutole and mesotrione.

Transgenes which have been used to provide herbicide tolerance traits comprise: for tolerance to glyphosate: cp4 epsps, epsps grg23ace5, mepsps, 2mepsps, gat4601, gat4621 and goxv247, for tolerance to glufosinate: pat and bar, for tolerance to 2,4-D: aad-1 and aad-12, for tolerance to dicamba: dmo, for tolerance to oxynil herbicies: bxn, for tolerance to sulfonylurea herbicides: zm-hra, csr1-2, gm-hra, S4-HrA, for tolerance to ALS inhibitor herbicides: csr1-2, for tolerance to HPPD inhibitor herbicides: hppdPF, W336 and avhppd-03.

Transgenic corn events comprising herbicide tolerance genes are for example, but not excluding others, DAS40278, MON801, MON802, MON809, MON810, MON832, MON87411, MON87419, MON87427, MON88017, MON89034, NK603, GA21, MZHG0JG, HCEM485, VCO-Ø1981-5,676,678, 680, 33121, 4114, 59122, 98140, Bt10, Bt176, CBH-351, DBT418, DLL25, MS3, MS6, MZIR098, T25, TC1507 and TC6275.

Transgenic soybean events comprising herbicide tolerance genes are for example, but not excluding others, GTS 40-3-2, MON87705, MON87708, MON87712, MON87769, MON89788, A2704-12, A2704-21, A5547-127, A5547-35, DP356043, DAS44406-6, DAS68416-4, DAS81419-2, GU262, SYHTØH2, W62, W98, FG72 and CV127.

Transgenic cotton events comprising herbicide tolerance genes are for example, but not excluding others, 19-51a, 31707, 42317, 81910, 281-24-236, 3006-210-23, BXN10211, BXN10215, BXN10222, BXN10224, MON1445, MON1698, MON88701, MON88913, GHB119, GHB614, LLCotton25, T303-3 and T304-40.

Transgenic canola events comprising herbicide tolerance genes are for example, but not excluding others, MON88302, HCR-1, HCN10, HCN28, HCN92, MS1, MS8, PHY14, PHY23, PHY35, PHY36, RF1, RF2 and RF3.

Insect resistance has mainly been created by transferring bacterial genes for insecticidal proteins to plants. Such plants are capable to synthesize one or more insecticidal proteins, especially those known from the bacterial genus Bacillus, particularly from Bacillus thuringiensis, such as delta-endotoxins, e. g., CryIA(b), CryIA(c), CryIF, CryIF(a2), CryIIA(b), CryIIIA, CryIIIB(b1) or Cry9c; vegetative insecticidal proteins (VIP), e. g., VIP1, VIP2, VIP3 or VIP3A; insecticidal proteins of bacteria colonizing nematodes, e. g., Photorhabdus spp. or Xenorhabdus spp.; toxins produced by animals, such as scorpion toxins, arachnid toxins, wasp toxins, or other insect-specific neurotoxins; toxins produced by fungi, such as Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilbene synthase, bibenzyl synthase, chitinases or glucanases. In the context of the present invention these insecticidal proteins or toxins are to be understood expressly also as including pre-toxins, hybrid proteins, truncated or otherwise modified proteins. Hybrid proteins are characterized by a new combination of protein domains, (see, e. g., WAO 02/015701). Further examples of such toxins or genetically modified crop plants capable of synthesizing such toxins are disclosed, e. g., in EP-A 374 753, WAO 93/007278, WO 95/34656, EP-A 427 529, EP-A 451 878, WO 03/18810 und WO 03/52073. The methods for producing such genetically modified crop plants are generally known to the person skilled in the art and are described, e. g., in the publications mentioned above. These insecticidal proteins contained in the genetically modified crop plants impart to the crop plants producing these proteins tolerance to harmful pests from all taxonomic groups of arthropods, especially to beetles (Coleoptera), two-winged insects (Diptera), and moths (Lepidoptera) and to nematodes (Nematoda). Genetically modified crop plants capable to synthesize one or more insecticidal proteins are, e. g., described in the publications mentioned above, and some of which are commercially available such as YieldGard® (corn cultivars producing the Cry1Ab toxin), YieldGard® Plus (con cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protecta®, Bt11 (e. g., Agrisure® CB) and Bt176 from Syngenta Seeds SAS, France, (corn cultivars producing the Cry1Ab toxin and PAT enzyme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

However, also genes of plant origin have been transferred to other plants. In particular genes coding for protease inhibitors, like CpTI and pinII. A further approach uses transgenes in order to produce double stranded RNA in plants to target and downregulate insect genes. An example for such a transgene is dvsnf7.

Transgenic corn events comprising genes for insecticidal proteins or double stranded RNA are for example, but not excluding others, Bt10, Bt11, Bt176, MON801, MON802, MON809, MON810, MON863, MON87411, MON88017, MON89034, 33121, 4114, 5307, 59122, TC1507, TC6275, CBH-351, MIR162, DBT418 and MZIR098.

Transgenic soybean events comprising genes for insecticidal proteins are for example, but not excluding others, MON87701, MON87751 and DAS-81419.

Transgenic cotton events comprising genes for insecticidal proteins are for example, but not excluding others, SGK321, MON531, MON757, MON1076, MON15985, 31707, 31803, 31807, 31808, 42317, BNLA-601, Event1, COT67B, COT102, T303-3, T304-40, GFM Cry1A, GK12, MLS 9124, 281-24-236, 3006-210-23, GHB119 and SGK321.

Increased yield has been created by increasing ear biomass using the transgene athb17, being present in corn event MON87403, or by enhancing photosynthesis using the transgene bbx32, being present in the soybean event MON87712.

Crops comprising a modified oil content have been created by using the transgenes: gm-fad2-1, Pj.D6D, Nc.Fad3, fad2-1A and fatb1-A. Soybean events comprising at least one of these genes are: 260-05, MON87705 and MON87769.

Tolerance to abiotic conditions, in particular to tolerance to drought, has been created by using the transgene cspB, comprised by the corn event MON87460 and by using the transgene Hahb-4, comprised by soybean event IND-ØØ41Ø-5.

Traits are frequently combined by combining genes in a transformation event or by combining different events during the breeding process. Preferred combination of traits are herbicide tolerance to different groups of herbicides, insect tolerance to different kind of insects, in particular tolerance to lepidopteran and coleopteran insects, herbicide tolerance with one or several types of insect resistance, herbicide tolerance with increased yield as well as a combination of herbicide tolerance and tolerance to abiotic conditions.

Plants comprising singular or stacked traits as well as the genes and events providing these traits are well known in the art. For example, detailed information as to the mutagenized or integrated genes and the respective events are available from websites of the organizations “International Service for the Acquisition of Agri-biotech Applications (ISAAA)” (http://www.isaaa.org/gmapprovaldatabase) and the “Center for Environmental Risk Assessment (CERA)” (http://cera-gmc.org/GMCropDatabase), as well as in patent applications, like EP3028573 and WO2017/011288.

The use of agrochemical compositions according to the invention on crops may result in effects which are specific to a crop comprising a certain gene or event. These effects might involve changes in growth behavior or changed resistance to biotic or abiotic stress factors. Such effects may in particular comprise enhanced yield, enhanced resistance or tolerance to insects, nematodes, fungal, bacterial, mycoplasma, viral or viroid pathogens as well as early vigor, early or delayed ripening, cold or heat tolerance as well as changed amino acid or fatty acid spectrum or content.

Furthermore, crop plants are also covered that are by the use of recombinant DNA techniques capable to synthesize one or more proteins to increase the resistance or tolerance of those crop plants to bacterial, viral or fungal pathogens. Examples of such proteins are the so-called “pathogenesis-related proteins” (PR proteins, see, e.g., EP-A 392 225), crop plant disease resistance genes (e. g., potato culti-vars, which express resistance genes acting against Phytophthora infestans derived from the Mexican wild potato, Solanum bulbocastanum) or T4-lyso-zym (e.g., potato cultivars capable of synthesizing these proteins with increased resistance against bacteria such as Erwinia amylovora). The methods for producing such genetically modified crop plants are generally known to the person skilled in the art and are described, e.g., in the publications mentioned above.

Furthermore, crop plants are also covered that are by the use of recombinant DNA techniques capable to synthesize one or more proteins to increase the productivity (e.g., bio-mass production, grain yield, starch content, oil content or protein content), tolerance to drought, salinity or other growth-limiting environmental factors or tolerance to pests and fungal, bacterial or viral pathogens of those crop plants.

Furthermore, crop plants are also covered that contain by the use of recombinant DNA techniques a modified amount of ingredients or new ingredients, specifically to improve human or animal nutrition, e. g., oil crops that produce health-promoting long-chain omega-3 fatty acids or unsaturated omega-9 fatty acids (e. g., Nexera® rape, Dow AgroSciences, Canada).

Furthermore, crop plants are also covered that contain by the use of recombinant DNA techniques a modified amount of ingredients or new ingredients, specifically to improve raw material production, e.g., potatoes that produce increased amounts of amylopectin (e.g. Amflora® potato, BASF SE, Germany).

Furthermore, it has been found that the agrochemical compositions are also suitable for the defoliation and/or desiccation of crop plant parts, of crop plants such as cotton, potato, oilseed rape, sunflower, soybean or field beans, in particular cotton. As desiccants, the agrochemical compositions according to the invention are suitable in particular for desiccating the aboveground parts of crop plants such as potato, oilseed rape, sunflower and soybean, but also cereals. This enables a fully mechanical harvesting of these important crop plants.

Also of economic interest is the facilitation of harvesting, which is made possible by concentrating within a certain period of time the dehiscence, or reduction of adhesion to the tree, in citrus fruit, olives and other species and varieties of pomaceous fruit, stone fruit and nuts. The same mechanism, i.e. the promotion of the development of abscission tissue between fruit part or leaf part and shoot part of the crop plants is also essential for the controlled defoliation of useful crop plants, in particular cotton.

Moreover, a shortening of the time interval in which the individual cotton crop plants mature leads to an increased fiber quality after harvesting.

Undesired vegetation to be controlled by the uses and methods of the invention are for example economically important monocotyledonous and dicotyledonous harmful plants, such as broad-leaved weeds, weed grasses or Cyperaceae. The active compounds also act efficiently on perennial weeds which produce shoots from rhizomes, root stocks and other perennial organs and which are difficult to control. Specific examples may be mentioned of some representatives of the monocotyledonous and dicotyledonous weed flora which can be controlled by the uses and methods of the invention, without the enumeration being restricted to certain species.

Examples of weed species on which the herbicidal compositions act efficiently are, from amongst the monocotyledonous weed species, Avena spp., Alopecurus spp., Apera spp., Brachiara spp., Bromus spp., Digitaria spp., Lolium spp., Echinochloa spp., Leptochloa spp., Fimbristylis spp., Panicum spp., Phalaris spp., Poa spp., Setaria spp. and also Cyperus species from the annual group, and, among the perennial species, Agropyron, Cynodon, Imperata and Sorghum and also perennial Cyperus species. In the case of the dicotyledonous weed species, the spectrum of action extends to genera such as, for example, Abutilon spp., Amaranthus spp., Chenopodium spp., Chrysanthemum spp., Galium spp., Ipomoea spp., Kochia spp., Lamium spp., Matricaria spp., Pharbitis spp., Polygonum spp., Sida spp., Sinapis spp., Solanum spp., Stellaria spp., Veronica spp. Eclipta spp., Sesbania spp., Aeschynomene spp. and Viola spp., Xanthium spp. among the annuals, and Convolvulus, Cirsium, Rumex and Artemisia in the case of the perennial weeds. In one embodiment, the undesired vegetation is of the genus Nasturtium, preferably Nasturtium officinale.

The agrochemical composition controls vegetation on non-crop areas very efficiently, especially at high rates of application. It acts against broad-leafed weeds and grass weeds in crops such as wheat, rice, corn, soybeans and cotton without causing any significant damage to the crop plants. This effect is mainly observed at low rates of application.

The agrochemical composition is usually applied to the plants by spraying the leaves. Here, the application can be carried out using, for example, water as carrier by customary spraying techniques using spray liquor amounts of from about 50 to 1000 I/ha (for example from 50 to 100 l/ha). Application may also involve the low-volume or the ultra-low-volume method, or the use of micro granules.

Application of the agrochemical composition be done before, during and/or after, preferably during and/or after, the emergence of the undesirable vegetation.

The agrochemical compositions can be applied pre- or post-emergence or together with the plant propagation material of a crop plant. It is also possible to apply the agrochemical composition by applying plant propagation material, pretreated with the agrochemical composition, of a crop plant. If dicamba-K, or the further active compounds are less well tolerated by certain crop plants, application techniques may be used in which the herbicidal compositions are sprayed, with the aid of the spraying equipment, in such a way that as far as possible they do not come into contact with the leaves of the sensitive crop plants, while the active compounds reach the leaves of undesirable plants growing underneath, or the bare soil surface (post-directed, lay-by).

Another advantage of the invention is that the application rates of dicamba-K may be reduced, thereby saving costs and time. This is achieved by minimizing the primary and secondary loss profile, as defined above.

In one embodiment, the invention relates to a method for reducing fine droplet formation of an aqueous composition comprising dicamba-K, comprising the step of contacting dicamba-K with additive a), b), and/or c), and water; and to the use of additive a), b), and/or c) for reducing fine droplet formation during spraying of an aqueous composition comprising dicamba-K.

The reduction of fine droplets may be measured by determining the “Fine Droplet Ratio”. The “Fine Droplet Ratio” can be determined by quantifying within an aqueous composition the fraction of fine droplets with a mean diameter of below 105 μm, such as below 100 μm, against the fraction of larger droplets above 100 μm at 20° C. A higher fine droplet ratio contributes to less effective application rates of the solution to the desired crop when sprayed by conventional agricultural sprayers.

The Fine Droplet Ratio is typically measured with flat spray tip nozzle, e.g. an AIXR nozzle (“TeeJet Flat Spray Tip”) or a TTI nozzle (“Turbo TeeJet Induction Flat Spray Tip”) at a pressure of 2.76 bar. Reduction of the spray drift is typically measured in relation the same composition without the additive(s).

The term “reducing fine droplet formation” typically relates to a comparison between an aqueous composition 1) containing dicamba-K, additive a), b), and/or c), and water, with an aqueous composition 2) containing dicamba-K, water, but none of additives a), b), or c). The reduction may be at least 10%, preferably at least 20%.

In another embodiment, the invention relates to a method for reducing the vapor pressure of an aqueous composition comprising dicamba-K, comprising the step of contacting dicamba-K with additive a), b), and/or c), and water; and to the use of additive a), b), and/or c) for reducing the vapor pressure of an aqueous composition comprising dicamba-K. The vapor pressure is typically measured in a closed system in thermodynamic equilibrium at 20° C. It may be measured according to DIN EN 13016-1:2018-06.

The term “reducing the vapor pressure” typically relates to a comparison between an aqueous composition 1) containing dicamba-K, additive a), b), and/or c), and water, with an aqueous composition 2) containing dicamba-K, water, but none of additives a), b), or c). The reduction may be at least 10%, preferably at least 20%.

The invention also relates to an adjuvant composition for increasing the solubility of dicamba-K as defined above comprising adjuvant c) and either adjuvant a) or

adjuvant b); and to an adjuvant composition for increasing the solubility of side products of dicamba-K as defined above comprising adjuvant c) and either adjuvant a) or adjuvant b).

The adjuvant composition(s) are usually free of water. Typically, the water content of the adjuvant composition is up to 1 wt %, preferably up to 0.5 wt %, more preferably up to 0.1 wt % based on the total weight of the adjuvant composition.

The adjuvant composition is generally free of pesticides, particularly preferably free of dicamba-K. The adjuvant composition may be added to dicamba-K during production of the aqueous agrochemical composition, or shortly before application in a tank mix. The adjuvant composition is usually free of water. It may contain water up to a concentration of 60 wt %, preferably up to 50 wt %, more preferably up to 40 wt %, most preferably up to 20 wt %, and particularly preferably up to 10 wt % based on the total weight of the adjuvant composition.

The concentration of adjuvant a) in the adjuvant composition may be from 5 to 95 wt %, preferably from 10 to 90 wt % based on the total weight of the composition. The concentration of adjuvant a) is typically at least 1 wt %, preferably at least 8 wt %, more preferably at least 12 wt % based on the total weight of the adjuvant composition.

The concentration of adjuvant b) in the adjuvant composition may be from 5 to 95 wt %, preferably from 10 to 90 wt % based on the total weight of the composition. The concentration of adjuvant b) is typically at least 1 wt %, preferably at least 8 wt %, more preferably at least 12 wt % based on the total weight of the adjuvant composition.

The concentration of adjuvant c) in the adjuvant composition may be from 5 to 95 wt %, preferably from 10 to 90 wt % based on the total weight of the composition. The concentration of adjuvant c) is typically at least 1 wt %, preferably at least 8 wt %, more preferably at least 12 wt % based on the total weight of the adjuvant composition.

The adjuvant composition(s) may comprise a co-solvent. Suitable co-solvents are water-miscible up to at least a ratio of the co-solvent to water of 1:1, preferably at least 2:1, more preferably at least 4:1.

Suitable co-solvents are alcohols, e.g. ethanol, propanol, butanol, benzyl alcohol, cyclohexanol; glycols; DMSO; ketones, e.g. heptanone, cyclohexanone; esters, e.g., carbonates, fatty acid esters, gamma-butyrolactone; fatty acids; phosphonates; amines; amides, e.g. fatty acid dimethylamides; and mixtures thereof. In one embodiment, the co-solvent is gamma-butyrolactone.

The concentration of the co-solvent in the adjuvant may be at least 1 wt %, preferably at least 2 wt %, more preferably at least 4 wt %, most preferably at least 5 wt %, based on the total weight of the agrochemical composition. The concentration of the co-solvent in the agrochemical formulation may be from 1 to 20 wt %, preferably from 1 to 10 wt %, more preferably from 2 to 8 wt %, most preferably from 4 to 7 wt %.

In one embodiment, the adjuvant composition comprises C₁-C₆-alkyl lactate, and additive a). In another embodiment, the adjuvant composition comprises ethyl lactate, and additive a), preferably wherein additive a) is as defined in embodiments PA-1 or PA-2, more preferably wherein additive a) is as defined in embodiment PA-2. In another embodiment, the adjuvant composition comprises n-propyl lactate, and additive a), preferably wherein additive a) is as defined in embodiments PA-1 or PA-2, more preferably wherein additive a) is as defined in embodiment PA-2.

In one embodiment, the adjuvant composition comprises N—C₁-C₁₅-alkyl pyrrolidone, and additive a). In another embodiment, the agrochemical composition comprises N-octyl pyrrolidone, and additive a), preferably wherein additive a) is as defined in embodiments PA-1 or PA-2, more preferably wherein additive a) is as defined in embodiment PA-2. In another embodiment, the adjuvant composition comprises N-butyl pyrrolidone, and additive a), preferably wherein additive a) is as defined in embodiments PA-1 or PA-2, more preferably wherein additive a) is as defined in embodiment PA-2. In another embodiment, the adjuvant composition comprises N-dodecyl pyrrolidone, and additive a), preferably wherein additive a) is as defined in embodiments PA-1 or PA-2, more preferably wherein additive a) is as defined in embodiment PA-2.

In one embodiment, the adjuvant composition comprises C₃-C₆-lactone, and additive a). In another embodiment, the adjuvant composition comprises gamma-butyrolactone, and additive a), preferably wherein additive a) is as defined in embodiments PA-1 or PA-2, more preferably wherein additive a) is as defined in embodiment PA-2. In another embodiment, the adjuvant composition comprises epsilon-caprolactone, and additive a), preferably wherein additive a) is as defined in embodiments PA-1 or PA-2, more preferably wherein additive a) is as defined in embodiment PA-2.

In one embodiment, the adjuvant composition comprises C₁-C₆-alkyl lactate, and additive b). In another embodiment, the adjuvant composition comprises ethyl lactate, and additive b), wherein additive b) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive b) a hyperbranched polycarbonate connected to polyethylene glycol monomethyl ether via a linker.

In another embodiment, the adjuvant composition comprises n-propyl lactate, and additive b), wherein additive b) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive b) a hyperbranched polycarbonate connected to polyethylene glycol monomethyl ether via a linker.

In one embodiment, the adjuvant composition comprises N—C₁-C₁₅-alkyl pyrrolidone, and additive b). In another embodiment, the adjuvant composition comprises N-octyl pyrrolidone, and additive b), wherein additive b) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive b) a hyperbranched polycarbonate connected to polyethylene glycol monomethyl ether via a linker.

In another embodiment, the adjuvant composition comprises N-butyl pyrrolidone, and additive b), wherein additive b) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive b) a hyperbranched polycarbonate connected to polyethylene glycol monomethyl ether via a linker.

In another embodiment, the adjuvant composition comprises N-dodecyl pyrrolidone, and additive b), wherein additive b) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive b) a hyperbranched polycarbonate connected to polyethylene glycol monomethyl ether via a linker.

In another embodiment, the adjuvant composition comprises C₃-C₆-lactone, and additive b), wherein additive b) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive b) a hyperbranched polycarbonate connected to polyethylene glycol monomethyl ether via a linker.

In another embodiment, the adjuvant composition comprises gamma-butyrolactone, and additive b), wherein additive b) is preferably a hyperbranched polycarbonate connected to a polyethylene glycol moo-C₁-C₁₈-alkyl ether, more preferably wherein the hyperbranched polycarbonate is connected to a polyethylene glycol monomethyl ether, most preferably wherein additive b) a hyperbranched polycarbonate connected to polyethylene glycol monomethyl ether via a linker.

The adjuvant composition may further comprise auxiliaries. Suitable auxiliaries are as defined above for the agrochemical composition.

The invention also relates to the use of additive a), b), c), or the adjuvant composition, for increasing the solubility of dicamba-K in an aqueous composition; and to a method for increasing the solubility of of dicamba-K in an aqueous composition comprising the step of contacting the additive a), b), c), or the adjuvant composition, with dicamba-K, and water.

It also relates to the use of additive a), b), c), or the adjuvant composition, for increasing the solubility of side products of dicamba-K in an aqueous composition; and to a method for increasing the solubility of side products of dicamba-K in an aqueous composition comprising the step of contacting the additive a), b), c), or the adjuvant composition, with dicamba-K, side products of dicamba-K, and water.

The term “increasing the solubility” as used herein means to increase the maximum concentration of dicamba-K, or of side products of dicamba-K that can be dissolved in a defined amount of aqueous agrochemical composition as compared to the same agrochemical composition without the additive. The solubility of dicamba-K or the side products of dicamba-K is typically measured at 20° C. in equilibrium.

Advantages: the agrochemical composition, and mixtures thereof with glyphosate and/or glufosinate have a low vapor pressure, and a decreased Fine Droplet Ratio. The agrochemical composition can be mixed with glyphosate and/or glufosinate, salts, and formulations thereof, in order to prepare co-formulated products of dicamba-K and glyphosate that are chemically and physically stable. The agrochemical composition can have very high concentrations of dicamba-K in dissolved state, while being safe for the applicant and having a high biological efficacy. The agrochemical composition may contain side products of the dicamba-K manufacturing process, but still stays stable, homogenous and transparent, and the side products remain dissolved in the liquid agrochemical composition.

The following examples illustrate the invention.

### EXAMPLES

The following ingredients were used for preparing the agrochemical compositions of the examples.

Dicamba-K-A: potassium salt of dicamba, 95.3% purity.

Dicamba-K-B: potassium salt of dicamba, 99.9% purity Dicamba-K-C: potassium salt of dicamba, 93.0% purity

Side products of dicamba material: 3,5-dichloro-2-methoxybenzoic acid, 3,6-dichloro-2-hydroxybenzoic acid, 3,5-dichloro-2-hydroxybenzoic acid, 3-chloro-2,6-dimethoxybenzoic acid, 3,4-dichloro-2-methoxybenzoic acid, 3,4-dichloro-2-hydroxybenzoic acid, 3,5-dichloro-4-methoxybenzoic acid and their potassium salts.

Dicamba-SL: 600 g/l solution of N,N-Bis-(3-aminopropyl)methylammonium salt of dicamba in water.

Polymer A: polyalkylene oxide block-copolymer of formula (I), wherein m is from 50 to 60, and n, p are independently from 45 to 55.

Polymer B: polyalkylene oxide block-copolymer of formula (I), wherein m is from 25 to 35, and n, p are independently from 70 to 80.

Polymer C: hyperbranched polycarbonate connected to methyl polyethylene glycol, prepared as described in Synthesis Example 5 of WO2010130599

Solvent A: n-propyl lactate

Solvent B: N-butyl pyrrolidone

Solvent C: N-octyl pyrrolidone

Solvent D: N-dodecyl pyrrolidone

Solvent E: gamma-butyrolactone

Adjuvant A: non-ionic adjuvant composition comprising dimethylpolysiloxane, alkanolamides, fatty acids, and alkyl aryl polyoxylkane ethers.

### Example-1

A soluble concentrate of dicamba-K-A was produced (SL-1). For this purpose, the following compounds were added in a vessel in the order and amount given in Table A. The resulting mixture was then stirred until a clear and homogeneous liquid was obtained.

TABLE A
components of SL-1 in [g]

| Compound | Amount |
|---|---|
| Dicamba-K-A | 56.9 |
| Demineralized H₂O | 46.75 |
| Solvent B | 6.68 |
| Solvent E | 6.68 |
| Polymer A | 6.68 |

### Example 2

Soluble concentrates SL-2 to SL-10 were produced in analogy to Example-1. The amount of the ingredients is listed in Table B.

TABLE B
components of SL-2 to SL-10 in [g].

| Compound | SL-2 | SL-3 | SL-4 | SL-5 | SL-6 | SL-7 | SL-8 | SL-9 | SL-10 |
|---|---|---|---|---|---|---|---|---|---|
| Dicamba-K-A | 56.66 | 56.66 | 56.66 | 56.66 | 56.66 | 56.66 | 56.66 | 56.66 | 56.66 |
| H₂O_{(demin.)} | 46.75 | 46.75 | 46.75 | 46.75 | 46.75 | 46.75 | 46.75 | 46.75 | 46.75 |
| Solvent A | — | — | 6.68 | — | — | — | — | — | — |
| Solvent B | — | — | — | 6.68 | — | — | 6.68 | — | — |
| Solvent C | 6.68 | — | — | — | 6.68 | — | — | 6.68 | — |
| Solvent D | — | 6.68 | — | — | — | 6.68 | — | — | 6.68 |
| Solvent E | 6.68 | 6.68 | 6.68 | 6.68 | 6.68 | 6.68 | 6.68 | 6.68 | 6.68 |
| Polymer A | 6.68 | 6.68 | — | — | — | — | — | — | — |
| Polymer B | — | — | 6.68 | 6.68 | 6.68 | 6.68 | — | — | — |
| Polymer C | — | — | — | — | — | — | 6.68 | 6.68 | 6.68 |

### Example-3

All soluble concentrates SL-1 to SL-10 were analyzed after preparation by visual inspection. SL-1 to SL-14 formed clear solutions comprising dicamba-K-A.

### Example-4

Comparative soluble concentrate SL-C₁ was prepared by mixing 66 wt % water and 44 wt % of Dicamba-K-A. Dicamba-K-A contained the following side products in the experimentally determined concentrations and concentration ranges provided in brackets: 3,5-dichloro-2-methoxybenzoic acid (10 to 70 g/kg), 3,6-dichloro-2-hydroxybenzoic acid (5 to 30 g/kg), 3,5-dichloro-2-hydroxybenzoic acid (0.5 to 25 g/kg).

The mixture formed a turbid liquid, full of matters in suspension that did not dissolve in the water and sedimented upon storage.

### Example-5

Fine Droplet Ratio properties of the diluted soluble concentrates SL-1 to SL-10 in admixture to glyphosate were analyzed. To this end, 1.22 L of a soluble concentrate selected from SL-1 to SL-14 was mixed with 2.07 L of a soluble concentrate comprising 540 g/l of the potassium salt of glyphosate (hereinafter “glyphosate-K”), which mixture was diluted with water to a total volume of 94 L. The resulting spray solution was then sprayed either with an AIXR nozzle (“TeeJet Flat Spray Tip”) or a TTI nozzle (“Turbo TeeJet Induction Flat Spray Tip”) at a pressure of 2.76 bar. The droplet size distribution was measured with a Sympatec Helos KF Laser diffraction device. Measurement was in 31 particle size classes from 18 to 3500 μm. Measurement was made at an angle of 0 at a distance of 30.5 cm from the nozzle. The analysis of data was based on 10 measurements collected in two runs. If necessary, the lenses were cleaned inbetween.

For comparison, a spray solution was prepared by mixing 0.93 L of an aqueous soluble concentrate containing 754 g/L dicamba N,N-bis-(3-aminopropyl)methylammonium (SL-C2) with 2.07 L of a soluble concentrate comprising 540 g/L of the potassium salt of glyphosate and diluted with water to a total volume of 94 L. Table D shows the fractions of fine droplets for the different nozzle types and the tested soluble concentrates SL-1 to SL-10 in comparison with SL-C2.

TABLE D
measurement of fine droplets <100 μm of SL-1 to SL-10 and SL-C2 after
admixture to glyphosate potassium salt and dilution with water

| | Fine droplets | Fine droplets with mean |
|---|---|---|
| Soluble | with mean diameter | diameter below 100 μm |
| concentrate | below 100 μm by spraying | by spraying with |
| tested | with AIXR nozzle in [%]. | TTI nozzle in [%]. |
| SL-1 | 7.6 | 1.23 |
| SL-2 | 8.79 | 0.89 |
| SL-3 | 6.87 | 1.18 |
| SL-4 | 7.03 | 1.25 |
| SL-5 | 8.49 | 1.19 |
| SL-6 | 10.05 | 0.87 |
| SL-7 | 7.71 | 0.62 |
| SL-8 | 8.9 | 1.44 |
| SL-9 | 9.53 | 0.97 |
| SL-10 | 7.28 | 1.08 |
| SL-C2 | 8.58 | 1.04 |

### Example 6

Soluble concentrates SL-11 to SL-37 were produced in analogy to Example-1. The amount of the ingredients is listed in Tables E, F, G, and H.

TABLE E
components of SL-11 to SL-18 in [g].

| Compound | SL-11 | SL-12 | SL-13 | SL-14 | SL-15 | SL-16 | SL-17 | SL-18 |
|---|---|---|---|---|---|---|---|---|
| Dicamba-K-A | 736.1 | 736.1 | 736.1 | 736.1 | 736.1 | 736.1 | 736.1 | 736.1 |
| H₂O_{(demin.)} | 313.9 | 310.1 | 281.9 | 366.5 | 366.5 | 388.3 | 422.9 | 422.9 |
| Solvent A | 50.0 | 56.4 | 84.6 | — | 56.4 | 84.6 | — | 56.4 |
| Polymer C | 200.0 | 197.4 | 197.4 | 197.4 | 141.0 | 141.0 | 141.0 | 84.6 |

TABLE F
components of SL-19 to SL-26 in [g].

| Compound | SL-19 | SL-20 | SL-21 | SL-22 | SL-23 | SL-24 | SL-25 | SL-26 |
|---|---|---|---|---|---|---|---|---|
| Dicamba-K-A | 736.1 | 736.1 | 736.1 | 736.1 | 736.1 | 736.1 | 736.1 | 736.1 |
| H₂O_{(demin.)} | 394.7 | 479.3 | 338.3 | 394.7 | 451.1 | 310.1 | 281.9 | 253.7 |
| Solvent A | 84.6 | — | 28.2 | 28.2 | 28.2 | 28.2 | 56.4 | 84.6 |
| Polymer C | 84.6 | 84.6 | 197.4 | 141.0 | 84.6 | 225.6 | 225.6 | 225.6 |

TABLE G
components of SL-27 to SL-34 in [g].

| Compound | SL-27 | SL-28 | SL-29 | SL-30 | SL-31 | SL-32 | SL-33 | SL-34 |
|---|---|---|---|---|---|---|---|---|
| Dicamba-K-A | 736.1 | 736.1 | 736.1 | 736.1 | 736.1 | 736.1 | 736.1 | 736.1 |
| H₂O_{(demin.)} | 253.7 | 310.1 | 366.5 | 338.3 | 451.1 | 422.9 | 394.7 | 366.5 |
| Solvent A | 112.8 | 112.8 | 112.8 | 141.0 | 84.6 | 112.8 | 141.0 | 169.2 |
| Polymer C | 197.4 | 141.0 | 84.6 | 84.6 | 28.2 | 28.2 | 28.2 | 28.2 |

TABLE H
components of SL-35 to SL-37 in [g].

| Compound | SL-35 | SL-36 | SL-37 |
|---|---|---|---|
| Dicamba-K-A | 736.1 | 736.1 | 736.1 |
| H₂O_{(demin.)} | 338.3 | 366.5 | 479.3 |
| Solvent A | 197.4 | 197.4 | 84.6 |
| Polymer C | 28.2 | — | — |

### Example 7

Soluble concentrates SL-12 to SL-37 were analyzed directly after preparation by visual inspection. The following soluble concentrates formed clear solutions: SL-12, SL-13, SL-14, SL-15, SL-16, SL-18, SL-19, SL-21, SL-22, SL-24, SL-28, SL-29, SL-30, SL-31, SL-31, SL-32, SL-33, SL-34, SL35, SL-36, SL-37.

The following soluble concentrates formed cloudy mixtures: SL-17, SL-23.

The following soluble concentrates formed turbid mixtures containing undissolved solid: SL-20, SL-25, SL-26, SL-27.

### Example 8

Soluble concentrates SL-12 to SL-24 and SL-28 to SL-37 were incubated at 54° C. for four weeks and then analyzed by visual inspection. The following soluble concentrates formed clear solutions: SL-12, SL-13, SL-14, SL-15, SL-16, SL-18, SL-19, SL-20, SL-21, SL-22, SL-23, SL24, SL-28, SL-29, SL-30, SL-31, SL-31, SL-32, SL-33, SL-34, SL35, SL-36, SL-37.

### Example 9

Soluble concentrates SL-12 to SL-24 and SL-28 to SL-37 were incubated at 0° C. for four weeks and then analyzed by visual inspection. The following soluble concentrates formed clear solutions: SL-12, SL-14, SL-15, SL-16, SL-18, SL-19, SL-21, SL-22, SL-28, SL-29, SL-30, SL-31, SL-32, SL-33, SL-34, SL-35, SL-36

The following soluble concentrates formed cloudy mixtures: SL-17

The following soluble concentrates formed crystals or precipitated solid: SL-13, SL-20, SL-23, SL-24, SL-37.

### Example 10

Soluble concentrates SL-12 to SL-24 and SL-28 to SL-37 were incubated at 10° C. for four weeks and then analyzed by visual inspection. The following soluble concentrates formed clear solutions: SL-12, SL-14, SL-15, SL-16, SL-18, SL-19, SL-21, SL-22, SL-28, SL-29, SL-30, SL31, SL-32, SL-33, SL-34, SL-35, SL-36

The following soluble concentrates formed cloudy mixtures: SL-17

The following soluble concentrates formed crystals or precipitated solid: SL-13, SL-20, SL-23, SL-24, SL-37.

### Example 11

Soluble concentrates SL-38 to SL-60 were produced in analogy to Example-1. The amount of the ingredients is listed in Tables J, K, and L.

TABLE J
components of SL-38 to SL-45 in [g].

| Compound | SL-38 | SL-39 | SL-40 | SL-41 | SL-42 | SL-43 | SL-44 | SL-45 |
|---|---|---|---|---|---|---|---|---|
| Dicamba-K-A | 736.1 | 736.1 | 736.1 | 736.1 | 736.1 | 736.1 | 736.1 | 736.1 |
| H₂O_{(demin.)} | 310.1 | 281.9 | 366.5 | 338.3 | 422.9 | 394.7 | 338.3 | 394.7 |
| Solvent B | 56.4 | 84.6 | 56.4 | 84.6 | 56.4 | 84.6 | 28.2 | 28.2 |
| Polymer C | 197.4 | 197.4 | 141.0 | 141.0 | 84.6 | 84.6 | 197.4 | 141.0 |

TABLE K
components of SL-46 to SL-53 in [g].

| Compound | SL-46 | SL-47 | SL-48 | SL-49 | SL-50 | SL-51 | SL-52 | SL-53 |
|---|---|---|---|---|---|---|---|---|
| Dicamba-K-A | 736.1 | 736.1 | 736.1 | 736.1 | 736.1 | 736.1 | 736.1 | 736.1 |
| H₂O_{(demin.)} | 451.1 | 310.1 | 281.9 | 253.7 | 253.7 | 310.1 | 366.5 | 338.3 |
| Solvent B | 28.2 | 28.2 | 56.4 | 84.6 | 112.8 | 112.8 | 112.8 | 141.0 |
| Polymer C | 84.6 | 225.6 | 225.6 | 225.6 | 197.4 | 141.0 | 84.6 | 84.6 |

TABLE L
components of SL-54 to SL-60 in [g].

| Compound | SL-54 | SL-55 | SL-56 | SL-57 | SL-58 | SL-59 | SL-60 |
|---|---|---|---|---|---|---|---|
| Dicamba-K-A | 736.1 | 736.1 | 736.1 | 736.1 | 736.1 | 736.1 | 736.1 |
| H₂O_{(demin.)} | 451.1 | 422.9 | 394.7 | 366.5 | 338.3 | 366.5 | 479.3 |
| Solvent B | 84.6 | 112.8 | 141.0 | 169.2 | 197.4 | 197.4 | 84.6 |
| Polymer C | 28.2 | 28.2 | 28.2 | 28.2 | 28.2 | — | — |

### Example 12

Soluble concentrates SL-61 to SL-72 were produced in analogy to Example-1. The amount of the ingredients is listed in Tables M, and N.

TABLE M
components of SL-61 to SL-68 in [g].

| Compound | SL-61 | SL-62 | SL-63 | SL-64 | SL-65 | SL-66 | SL-67 | SL-68 |
|---|---|---|---|---|---|---|---|---|
| Dicamba-K-A | 736.1 | 736.1 | 736.1 | 736.1 | 736.1 | 736.1 | 736.1 | 736.1 |
| H₂O_{(demin.)} | 253.7 | 253.7 | 310.1 | 366.5 | 338.3 | 451.1 | 422.9 | 394.7 |
| Solvent E | 84.6 | 112.8 | 112.8 | 112.8 | 141.0 | 84.6 | 112.8 | 141.0 |
| Polymer C | 225.6 | 197.4 | 141.0 | 84.6 | 84.6 | 28.2 | 28.2 | 28.2 |

TABLE N
components of SL-69 to SL-72 in [g].

| Compound | SL-69 | SL-70 | SL-71 | SL-72 |
|---|---|---|---|---|
| Dicamba-K-A | 736.1 | 736.1 | 736.1 | 736.1 |
| H₂O_{(demin.)} | 366.5 | 338.3 | 366.5 | 479.3 |
| Solvent E | 169.2 | 197.4 | 197.4 | 84.6 |
| Polymer C | 28.2 | 28.2 | — | — |

### Example 13

Soluble concentrates SL-61 to SL-72 were analyzed directly after preparation by visual inspection. The following soluble concentrates formed clear solutions: SL-63, SL-64, SL-65, SL-66, SL-67, SL-68, SL-69, SL-70, SL-71.

The following soluble concentrates formed turbid mixtures containing undissolved solid: SL-61, SL-62, SL-72.

### Example 14

Soluble concentrates SL-61 to SL-72 were analyzed after incubation for four weeks at 54° C. by visual inspection. The following soluble concentrates formed clear solutions: SL-63, SL-64, SL65, SL-66, SL-67, SL-68, SL-69, SL-70, SL-71.

The following soluble concentrates formed turbid mixtures containing undissolved solid: SL-61, SL-62, SL-72.

### Example 15

The Fine Droplet Ratio properties of the diluted soluble concentrates SL-30 to SL-37 in admixture to glyphosate were analyzed. To this end, 0.94 L of a soluble concentrate selected from SL-1 to SL-14 was mixed with 2.07 L of a soluble concentrate comprising 540 g/l of the potassium salt of glyphosate, which mixture was diluted with water to a total volume of 94 L. The resulting spray solution was then sprayed either with an AIXR nozzle (“TeeJet Flat Spray Tip”) with a pressure of 2.76 bar or a TTI nozzle (“Turbo TeeJet Induction Flat Spray Tip”) at a pressure of 4.13 bar. The droplet size distribution was measured with a Sympatec Helos KF Laser diffraction device. Measurement was in 31 particle size classes from 18 to 3500 μm. Measurement was made at an angle of 0° at a distance of 30.5 cm from the nozzle. The analysis of data was based on 10 measurements collected in two runs. If necessary, the lenses were cleaned inbetween.

For comparison, a spray solution was prepared by mixing 0.93 L of an aqueous soluble concentrate containing 754 g/L dicamba N,N-bis-(3-aminopropyl)methylammonium (SL-C3) with 2.07 L of a soluble concentrate comprising 540 g/L of the potassium salt of glyphosate and diluted with water to a total volume of 94 L. Table P showed the fractions of fine droplets for the different nozzle types and the tested soluble concentrates SL-30 to SL-37 in comparison with SL-C₃.

TABLE P
measurement of fine droplets <100 μm of SL-30 to SL-37 and SL-C3 after
admixture to glyphosate potassium salt and dilution with water

| | Fine droplets with | Fine droplets with |
|---|---|---|
| Soluble | mean diameter below | mean diameter below |
| concentrate | 100 μm by spraying | 100 μm by spraying with |
| tested | with AIXR nozzle in [%]. | TTI nozzle in [%]. |
| SL-30 | 8.35 | 3.55 |
| SL-31 | 8.25 | 3.21 |
| SL-32 | 7.96 | 3.24 |
| SL-33 | 8.20 | 3.25 |
| SL-34 | 8.02 | 3.26 |
| SL-35 | 8.39 | 3.36 |
| SL-36 | 8.28 | 3.35 |
| SL-37 | 8.23 | 3.51 |
| SL-C3 | 8.4 | 3.14 |

### Example 16

Soluble concentrates SL-73 to SL-108 were produced in analogy to Example-1. The amount of the ingredients is listed in Tables Q, R, S, T, U, and V.

TABLE Q
components and densities of SL-73 to SL-80.

| Compound | SL-73 | SL-74 | SL-75 | SL-76 | SL-77 | SL-78 | SL-79 | SL-80 |
|---|---|---|---|---|---|---|---|---|
| Dicamba-K-A [g] | 736.1 | 736.1 | 736.1 | 736.1 | 736.1 | 736.1 | 736.1 | 736.1 |
| Solvent A [g] | — | 84.6 | 28.2 | 112.8 | — | — | — | — |
| Solvent B [g] | — | — | — | — | — | — | — | — |
| Solvent E [g] | — | — | — | — | 84.6 | 84.6 | 112.8 | 169.2 |
| Polymer B [g] | — | — | — | — | — | — | — | — |
| Polymer C [g] | 197.4 | 84.6 | 141 | 141 | 141 | 84.6 | 84.6 | 28.2 |
| Water [g] | 366.5 | 394.7 | 394.7 | 310.1 | 338.3 | 394.7 | 366.5 | 366.5 |
| Density [g/ml] at | 1.33 | 1.319 | 1.325 | 1.323 | 1.337 | 1.331 | 1.335 | 1.338 |
| 20° C. | | | | | | | | |

TABLE R
components of SL-81 to SL-85 in [g].

| Compound | SL-81 | SL-82 | SL-83 | SL-84 | SL-85 | SL-86 | SL-87 |
|---|---|---|---|---|---|---|---|
| Dicamba-K-A [g] | 736.1 | — | — | — | — | — | |
| Dicamba-K-C [g] | — | 756.3 | 756.3 | 755.9 | 755.9 | 755.9 | 755.9 |
| Solvent A [g] | 56.4 | 16.92 | 56.4 | 84.6 | 112.8 | — | — |
| Solvent B [g] | — | 50.76 | 112.8 | — | — | — | — |
| Solvent E [g] | — | 16.92 | — | — | — | 84.6 | 84.6 |
| Polymer B [g] | — | — | — | 84.6 | 141 | 141 | 84.6 |
| Polymer C [g] | 141.0 | 84.6 | 28.2 | — | — | — | — |
| Water | 366.5 | 389.5 | 361.27 | 375.2 | 290.6 | 318.8 | 375.2 |
| Density [g/ml] at | 1.321 | 1.315 | 1.315 | 1.332 | 1.338 | N.A. | 1.345 |
| 20° C. | | | | | | | |

TABLE S
components of SL-86 to SL-92 in [g].

| Compound | SL-88 | SL-89 | SL-90 | SL-91 | SL-92 |
|---|---|---|---|---|---|
| Dicamba-K-C [g] | 755.9 | 755.9 | 755.9 | 756.3 | 756.3 |
| Solvent A [g] | — | — | — | 16.92 | 56.4 |
| Solvent B [g] | — | — | 56.4 | 50.76 | 112.8 |
| Solvent E [g] | 112.8 | 169.2 | — | 16.92 | — |
| Polymer B [g] | 84.6 | 28.2 | 141.0 | 84.6 | 28.2 |
| Polymer C [g] | — | — | — | — | — |
| Water [g] | 347.0 | 347.0 | 347.0 | 389.5 | 361.27 |
| Density [g/ml] at | 1.348 | 1.349 | N.A. | 1.314 | 1.328 |
| 20° C. | | | | | |

TABLE T
components and densities of SL-93 to SL-100.

| Compound | SL-93 | SL-94 | SL-95 | SL-96 | SL-97 | SL-98 | SL-99 | SL-100 |
|---|---|---|---|---|---|---|---|---|
| Dicamba-K-B [g] | 755.6 | 755.6 | 755.6 | 755.6 | 755.6 | 755.6 | 755.6 | 755.6 |
| Solvent A [g] | — | 84.6 | 28.2 | 112.8 | — | — | — | — |
| Solvent B [g] | — | — | — | — | — | — | — | — |
| Solvent E [g] | — | — | — | — | 84.6 | 84.6 | 112.8 | 169.2 |
| Polymer B [g] | — | — | — | — | — | — | — | — |
| Polymer C [g] | 197.4 | 84.6 | 141 | 141 | 141 | 84.6 | 84.6 | 28.2 |
| Water [g] | 366.5 | 394.7 | 394.7 | 310.1 | 338.3 | 394.7 | 366.5 | 366.5 |
| Density [g/ml] at | 1.34 | 1.3 | 1.3 | 1.331 | 1.346 | 1.342 | 1.345 | 1.348 |
| 20° C. | | | | | | | | |

TABLE U
components of SL-101 to SL-107 in [g].

| Compound | SL-101 | SL-102 | SL-103 | SL-104 | SL-105 | SL-106 | SL-107 |
|---|---|---|---|---|---|---|---|
| Dicamba-K-B [g] | 755.6 | 703 | 703 | 703 | 703 | 703 | 703 |
| Solvent A [g] | 56.4 | 16.92 | 56.4 | 84.6 | 112.8 | — | — |
| Solvent B [g] | — | 50.76 | 112.8 | — | — | — | — |
| Solvent E [g] | — | 16.92 | — | — | — | 84.6 | 84.6 |
| Polymer B [g] | — | — | — | 84.6 | 141 | 141 | 84.6 |
| Polymer C [g] | 141.0 | 84.6 | 28.2 | — | — | — | — |
| Water | 366.5 | 389.5 | 361.27 | 375.2 | 290.6 | 318.8 | 375.2 |
| Density [g/ml] at | 1.331 | 1.305 | 1.305 | 1.282 | 1.312 | N.A. | 1.317 |
| 20° C. | | | | | | | |

TABLE V
components of SL-108 to SL-112 in [g].

| Compound | SL-108 | SL-109 | SL-110 | SL-111 | SL-112 |
|---|---|---|---|---|---|
| Dicamba-K-B [g] | 703 | 703 | 703 | 703 | 703 |
| Solvent A [g] | — | — | — | 16.92 | 56.4 |
| Solvent B [g] | — | — | 56.4 | 50.76 | 112.8 |
| Solvent E [g] | 112.8 | 169.2 | — | 16.92 | — |
| Polymer B [g] | 84.6 | 28.2 | 141.0 | 84.6 | 28.2 |
| Polymer C [g] | — | — | — | — | — |
| Water [g] | 347.0 | 347.0 | 347.0 | 389.5 | 361.27 |
| Density [g/ml] at | 1.322 | 1.322 | N.A. | 1.305 | 1.294 |
| 20° C. | | | | | |

### Example 17

An atomization study was conducted to measure Fine Droplet Ratios produced by spraying simulated spray tank mixtures through a Turbo Teejet Induction (TTI) 11004 nozzle at a pressure of 63 psi to simulate ground boom applications. Spray tank mixtures contained the soluble concentrates as indicated in Table W at a final concentration of 1 wt %, Adjuvant A at a final concentration of 0.25 wt %, and water. The spray droplet size spectra were measured using a laser diffraction particle size analyzer. Data were expressed as the entire droplet size spectra and compared using the spray volume contained in relatively small droplets with mean diameter between 2-105 um and 2-141 μm. A tank mix containing Dicamba-SL at a final concentration of 1 wt %, Adjuvant A at a final concentration of 0.25 wt % and water was used as a control (SL-C4).

TABLE W
measurement of fine droplets of SL-73 to SL-81 and SL-C4

| Soluble | Fine droplets with mean | Fine droplets with mean |
|---|---|---|
| concentrate | diameter between | diameter between |
| tested | 2 and 105 μm in [%] | 2 and 141 μm in [%] |
| SL-73 | 0.39 | 0.86 |
| SL-74 | 0.43 | 0.94 |
| SL-75 | 0.43 | 0.92 |
| SL-76 | 0.41 | 0.90 |
| SL-77 | 0.52 | 1.06 |
| SL-78 | 0.56 | 1.11 |
| SL-79 | 0.57 | 1.13 |
| SL-80 | 0.63 | 1.19 |
| SL-81 | 0.40 | 0.88 |
| SL-C4 | 0.42 | 0.88 |

### Example 18

Soluble concentrates SL-78 to SL-108 were analyzed for their volatility in the presence of glyphosate-K. To this end, 0.94 L of a soluble concentrate selected from SL-78 to SL-108 was mixed with 2.07 L of a soluble concentrate comprising 540 g/l of the potassium salt of glyphosate, which mixture was diluted with water to a total volume of 94 L. Samples were further diluted with water to ensure similar amounts of active ingredients per area in the test tubes as obtained by spraying the active ingredients at the recommended application rates in the field. The samples were then incubated in glass tubes that were contained in water baths. The samples were incubated for 24 hours at 70° C. Volatilized sample material was constantly removed from the tubes by an air conduct. Residual amounts of dicamba are determined relative to the applied amount. The reported volatility is [1−(residual amount/applied amount)] in percent. The results were summarized in Tables X to AB below.

TABLE X
Volatility measured in a Büchi Multivapor P-12 for samples SL-73 to SL-81

| | Soluble concentrate | | | | | | | | |
|---|---|---|---|---|---|---|---|---|---|
| | SL-73 | SL-74 | SL-75 | SL-76 | SL-77 | SL-78 | SL-79 | SL-80 | SL-81 |
| Volatility [%] | 5.0 | 5.3 | 6.2 | 5.7 | 3.9 | 5.3 | 6.0 | 5.9 | 6.1 |

TABLE Y
Volatility measured in a Büchi Multivapor P-12 for samples SL-82 to SL-90.

| | Soluble concentrate | | | | | | | | |
|---|---|---|---|---|---|---|---|---|---|
| | SL-82 | SL-83 | SL-84 | SL-85 | SL-86 | SL-87 | SL-88 | SL-89 | SL-90 |
| Volatility [%] | 16.0 | 10.6 | 10.6 | 10.7 | n.m. | 11.4 | 10.2 | 18.0 | n.m. |

n.m. = not measured

TABLE Z
Volatility measured in a Büchi Multivapor P-12 for samples SL-91 to SL-97

| | Soluble concentrate | | | | | | |
|---|---|---|---|---|---|---|---|
| | SL-91 | SL-92 | SL-93 | SL-94 | SL-95 | SL-96 | SL-97 |
| Volatility [%] | 13.7 | 11.3 | 10.4 | 4.1 | 9.9 | 5.8 | 5.3 |

TABLE AA
Volatility measured in a Büchi Mutivapor P-12 for samples SL-98 to SL-104

| | Soluble concentrate | | | | | | |
|---|---|---|---|---|---|---|---|
| | SL-98 | SL-99 | SL-100 | SL-101 | SL-102 | SL-103 | SL-104 |
| Volatility [%] | 6.9 | 10.5 | 5.5 | 11.5 | 7.6 | 8.2 | 6.9 |

TABLE AB
Volatility measured in a Büchi Multivapor P-12 for samples SL-105 to SL-112.

| | Soluble concentrate | | | | | | | |
|---|---|---|---|---|---|---|---|---|
| | SL-105 | SL-106 | SL-107 | SL-108 | SL-109 | SL-110 | SL-111 | SL-112 |
| Volatility [%] | 6.3 | n.m. | 10.8 | 9.0 | 13.0 | n.m. | 10.9 | 14.5 |

n.m. = not measured.

### Example 19

A quantitative Humi-Dome study was carried out. To this end, two treated glass plates were placed in a plastic tray, which was covered with a clear plastic Humi-Dome (overall size 25 cm wide×50 cm long×20 cm tall by Hummert International). The Humi-Dome was fitted with an air sampling filter cassette containing fiberglass and cotton pad filter media, which was connected to a vacuum pump with a flow rate of 2 liters per minute. Individual Humi-Domes representing different study treatments and replicates were placed in a controlled growth chamber environment of 35° C. and 25 to 40% humidity. Soluble concentrates SL-73 to SL-81 as well as comparative soluble concentrate SL-C5 containing a control Dicamba-SL were tested in tank-mixes with water and 0.25 vol-% of Adjuvant A. Treatments were applied to the glass plates using a laboratory track sprayer using a TeeJet 95015E nozzle by Spraying Systems and a 146 U/ha spray volume. The application rate of dicamba was 560 grams of acid equivalent per hectare. After 24 hours of air sampling, filters were collected, extracted and analyzed for dicamba content using gas-chromatography coupled mass spectrometry. The total amount of dicamba captured was then divided by total volume of the air flow through the filter to calculate the total amount dicamba captured/unit volume of air and the relative reduction of dicamba captured in the filter compared to SC-C₅ as summarized in Table AC.

TABLE AD
reduction of dicamba captured in filter compared with the control
as measured in Humi-Dome assay [%].

| | Reduction of dicamba captured in |
|---|---|
| Soluble concentrate | filter relative to SL-C5 [%] |
| SL-C5 | — |
| SL-73 | 77 |
| SL-74 | 73 |
| SL-75 | 69 |
| SL-76 | 71 |
| SL-77 | 74 |
| SL-78 | 68 |
| SL-79 | 66 |
| SL-80 | 72 |
| SL-81 | 75 |

### Example 19

A quantitative Humi-Dome study was carried out as described in Example 18 with the difference that glyphosate-K was added to the tank-mixes. SL-C was used as a comparative sample consisting of dicamba-K in water. The application rate of glyphosate was 1120 grams of acid equivalents per hectare. After 24 hours, filters were collected, extracted and analyzed for dicamba content using gas-chromatography coupled mass spectrometry. The total amount of dicamba captured was then divided by total volume of the air flow through the filter to calculate the relative reduction of dicamba captured in the filter compared with SC-C₆ as summarized in Table AE.

TABLE AE
reduction of dicamba captured in filter compared with SL-C6
as measured in Humi-Dome assay [%].

| | Reduction of dicamba captured in |
|---|---|
| | filter relative to SL-C6 with |
| Soluble Concentrate | glyphosate-K [%] |
| SL-C6 with glyphosate-K | — |
| SL-77 with glyphosate-K | 46 |
| SL-79 with glyphosate-K | 36 |
| SL-80 with glyphosate-K | 54 |
| SL-81 with glyphosate-K | 27 |

1. An aqueous agrochemical composition comprising the potassium salt of dicamba, and an additive selected from the group consisting of
a) a polyalkylene oxide block-copolymer of formula (I)
R¹O(EO)ₙ(PO)ₘ(EO)ₚR² (I),
wherein
EO is CH₂CH₂O;
PO is CH₂CH(CH₃)O;
R¹, R² are H, or C₁-C₃-alkyl;
n, p are independently a natural number from 10 to 250, preferably 20 to 200; and
m is a natural number from 10 to 100, preferably 20 to 70;
b) a hyperbranched polycarbonate, which is connected to a linear polymer comprising polyethylene oxide; and
c) a solvent selected from C₁-C₆-alkyl lactate, C₃-C₆-lactone and N—C₁-C₁₅-alkyl pyrrolidone.

2. The agrochemical composition according to claim 1 comprising additive a), wherein the ratio of (n+p)/m in formula I is 1:1 to 10:1.

3. The agrochemical composition according to claim 1 comprising additive b), wherein the hyperbranched polycarbonate is connected to a polyethyleneglycol-mono-C₁-C₁₈-alkylether.

4. The agrochemical composition according to claim 1 comprising additive b), wherein the hyperbranched polycarbonate contains a polyetherol based on an alcohol with at least 3 OH groups and 1 to 30 molecules alkylene oxide.

5. The agrochemical composition according to claim 1 comprising glyphosate and/or glufosinate and/or pyroxasulfone.

6. The agrochemical composition according to claim 1, wherein the potassium salt of dicamba is present in an amount of at least 55 wt % based on the total weight of the agrochemical composition.

7. The agrochemical composition according to claim 1 containing mixture of additive a) or additive b), and additive c).

8. The agrochemical composition according to claim 1 containing at least 22 wt % of water based on the total weight of the formulation.

9. The agrochemical composition according to claim 1, wherein a concentration of a sum of all additives a), b), and c), is from 1 to 35 wt % based on the total weight of the agrochemical composition.

10. The agrochemical composition according to claim 1 containing a side product of dicamba-K selected from the group consisting of 3,5-dichloro-2-methoxybenzoic acid, 3,6-dichloro-2-hydroxybenzoic acid, 3,5-dichloro-2-hydroxybenzoic acid, 3-chloro-2,6-dimethoxybenzoic acid, 3,4-dichloro-2-methoxybenzoic acid, 3,4-dichloro-2-hydroxybenzoic acid, and/or 3,5-dichloro-4-methoxybenzoic acid, and a potassium salt of any of them.

11. The agrochemical composition according to claim 10, wherein the concentration of the side product is at least 1 wt % based on the total weight of the agrochemical composition.

12. A method for producing the agrochemical composition as defined in claim 1 comprising the step of contacting dicamba-K with the additive as defined in claim 1.

13. A method of controlling undesired vegetation, and/or for regulating the growth of plants, wherein the agrochemical composition, as defined in claim 1, is allowed to act on the respective pests, their environment, or the crop plants to be protected from the respective pest, on the soil and/or on the crop plants and/or on their environment.

14. An adjuvant composition for increasing the solubility of dicamba-K in an aqueous composition, comprising a mixture of the additive a) or the additive b) and additive c) as defined in claim 1.

15. A method for reducing the spray drift of an aqueous composition comprising the potassium salt of dicamba, comprising the step of contacting the potassium salt of dicamba with additive a), b), or c) as defined in claim 1, and water.
